(19) United States
(12) Patent Application Publication
(10) Pub. No.: US 2009/0174107 A1
(43) Pub. Date: Jul. 9, 2009

(54) Shaping Device and Method for Shaping and Cooling Articles, Especially Hollow Profiles

(75) Inventor: Reinhold Kössl, Wartberg/Krems (AT)

Correspondence Address: Workman Nydegger;1000 Eagle Gate Tower, 60 East South Temple, Salt Lake City, UT, 84111, US

(73) Assignee: GREINER EXTRUSIONSTECHNIK GMBH, Nussbach (AT)

(21) Appl. No.: 11/719,393

(22) PCT Filed: Nov. 14, 2005
(86) PCT No.: PCT/AT2005/000452

§ 371 Date: Aug. 20, 2007

(30) Foreign Application Priority Data
Nov. 15, 2004 (AT) A 1901/2004

(51) Int. Cl. B29C 47/00

(52) U.S. Cl. 264/167; 425/378.1

(57) ABSTRACT

The invention relates to a shaping device (3) for shaping and cooling articles produced from a plastic melt, whereby said device can be arranged downstream of an extruder. The shaping device (3) comprises, arranged in an entry area (19), an inlet opening (20) for the plastic melt, at least one channel (21) extending in the direction of an outlet area (22) and having channel walls (23, 24) delimiting the same, and at least one cooling device (27) associated with the channel walls (23, 24). An additional cooling device (28) for the plastic melt to be passed through is provided inside the channel (21) in the area directly adjacent to the inlet area (19).

The invention relates to a shaping device and to a method for shaping and cooling articles, especially hollow profiles, as described in claims 1, 2, 47 and 48.

EP 0 817 715 B1 and U.S. Pat. No. 5,945,048 A and DE 195 10 944 C1 disclose a method and a device for extruding polymer melts to form hollow chamber profiles. In the case of this method, the polymer melt is forced through a heated profile die with an inner profile mandrel, the profile die and the profile mandrel already determining the outer and inner contours of the hollow chamber profile to be produced. Following this forming operation, the hollow chamber profile strand exiting from the profile die is cooled in a calibrating and cooling unit arranged directly downstream of the profile die. By arranging the profile die and the calibrating and cooling unit directly downstream of one another, the pressure that is built up in the profile die is maintained right through into the calibrating and cooling unit. Consequently, the hollow chamber profile to be produced is pressed or pushed by the pressure exerted by the extruder from the profile die both through the profile die and through the calibrating and cooling unit. In the case of this known device or the known method, the shaping of the polymer melt takes place in the heated profile die, while the cooling of the hollow chamber profile takes place in the calibrating and cooling unit arranged downstream of the profile die.

A further device for handling extruded polymer melts is disclosed by U.S. Pat. No. 5,132,062 A, in which a dedicated cooling element and a calibrating device are arranged directly downstream of the extrusion die or the exit gap of the extrusion die for the polymer melt. The handling device for heat extraction is arranged in the core region of the article to be produced and extends from the cooling element into the calibrating device. The handling device, in particular heat extraction device, in the region of the calibrating device is supplied through dedicated supply lines, which are led through a multi-wall sheet into the core region of the extrusion die. In this case, the supply lines are thermally insulated from the components of the extrusion die in the region of the multi-wall sheet and up to the die gap, that is to say where the polymer melt exits from the extrusion die, by an air gap. In the case of this known device, the heat extraction from the polymer melt takes place directly after it exits from the extrusion die in the region of the calibrating device, both on the outer side and on the inner side of the article.

Another method and device for producing hollow molded parts are disclosed by DE 24 34 383 A1, in which the polymer melt is fed to an extrusion die and the webs inside the hollow profile are formed simultaneously in it. A cooling and calibrating device is arranged downstream of where the strand of plastic formed in this way exits. At end faces of the core or mandrel, lines end or open out in the hollow spaces formed by the profile shell or the webs, a gas being forced alternately through these lines into the hollow spaces, so that the dividing walls are alternately pressed against adjacent dividing walls or the outer wall and fused with them or it. At the same time, expansion of the outer wall is prevented by the cooling device alongside the die body.

The present invention is based on the object of providing a shaping device and a method for shaping and cooling articles, especially hollow profiles, such as hollow chamber profiles, with which a dimensionally stable profile can be achieved without any adjustment effort.

This object of the invention is achieved by an additional cooling device for the polymer melt that is to be passed through being arranged within the channel in the region that is directly adjacent or downstream of the entry area. The resultant surprising advantage is that the shaping device according to the invention dispenses with a previously known form of the extrusion die for shaping the hot melt strand, and the melt strand of the polymer melt that is prepared by the extruder and enters the shaping device is cooled after the direct entry area within the channel by an additional cooling device arranged there. As a result, a great amount of heat is extracted from the polymer melt and, even after a short passage through the shaping device, the polymer melt is cooled to such an extent that forming of the cooled or pre-cooled melt strand into the desired profile geometry is still possible within the shaping device.

Independently of this, the object of the invention is also achieved, however, by the channel having in a portion opening out in or facing the exit area a cross section which corresponds to the article to be produced and by the channel having in a portion arranged directly upstream of this portion in the direction of extrusion a cross section that is smaller in comparison. This controlled constriction of the melt strand passing through has the effect of improving the sliding properties of the plastic material on the following channel walls and in this way achieving a solid flow even before the article to be produced emerges. As a result, a ready-shaped and dimensionally stable profile is in turn achieved in the region of the exit area of the same from the shaping device.

In the refinement as claimed in claim 3, it is of advantage that the melt or the melt strand prepared by the extruder is also cooled in its interior after the direct entry area within the channel. As a result, a great amount of heat is extracted from the polymer melt and, even after a short passage through the shaping device, the polymer melt is cooled to such an extent that forming of the cooled or pre-cooled melt strand into the desired profile geometry is still possible within the shaping device.

The development as claimed in claim 4 achieves the effect that, directly after it enters the shaping device, the melt strand exiting from the extruder is formed into that profile contour or profile cross section that corresponds virtually to that cross section or profile contour of the article to be produced. As a result, a simple construction of the shaping device is achieved, it being possible nevertheless for an adequate amount of heat to be extracted by the shaping device from the polymer material passing through.

A further development as claimed in claim 5 is also advantageous, since in this way it is possible already shortly after entry into the shaping device for an adequate amount of heat to be extracted from those profile sections of the hollow profile that make up a high proportion in terms of volume, and the polymer melt required for forming the webs is not initially affected by this cooling.

Furthermore, a form as claimed in claim 6 is advantageous, since a maximum surface area achievable for the cooling of the melt strand is in this way achieved in an extremely small space, whereby a great amount of heat can be removed from the interior of the melt strand.

The form as claimed in claim 7 makes it possible to form between the outer regions of the additional cooling device that are facing the channel walls and the channel walls an undivided or uninterrupted, circumferentially continuous partial melt strand, which is only interrupted in its interior up to a certain distance by the cooling device while it passes through. As a result, the strength properties of the article to be produced are not adversely influenced.

According to another configurational variant as claimed in claim 8, with simultaneous reduction of the outer dimensions of the channel wall, a reduction of the channel cross section is achieved and this is conducive to the passing through of the polymer melt in the direction of the further circumferential region.

Developments as claimed in claims 9 to 11 are also advantageous, since as a result a high coolant throughput through the cooling device and forced circulation can be achieved, and as a result fresh water resources can additionally also be saved. The closed circulation also has the effect for example that the use of pressurized water is possible, since evaporation or vapor formation is prevented as a result.

In the case of the refinement as claimed in claim 12, it is of advantage that the polymer melt entering the shaping device can be deformed over its longitudinal course to different distances, with respect to the center, according to the requirements for cooling and the necessary forming. With an appropriate increase in the spacings of the channels, with respect to the center, the rate at which the melt stream passes through can be reduced, with respect to the amount of throughput, whereby an even longer period of time is available for extracting heat from the polymer melt.

The development as claimed in claim 13 achieves the effect that as a result adequately pre-cooled material is always available for forming the profile geometry in the end region of the shaping device.

The form as claimed in claim 14 can be advantageously used to achieve a widening of the melt strand entering the shaping device, whereby an increase in the throughflow cross section can also be achieved over a short distance.

A form as claimed in claim 15 is also advantageous, since as a result, in addition to the heat extracted from its interior, an adequate amount of heat can also be extracted from the melt strand passing through the channel at the partial flows facing the channel walls.

According to a form as described in claim 16, simple, standard production processing operations can be used at any time in the shaping device in this area and, in addition, concentric widening of the melt strand exiting from the extruder takes place in this area.

At the same time, a refinement as claimed in claim 17 proves to be advantageous, since as a result a predeterminable decrease in the channel cross section can already be created for the transitional region for forming the final profile geometry.

According to an advantageous development as claimed in claim 18 or 19, the final forming of the forming of the article to be produced is already ensured in the end portion of the shaping device, and so the article is established in its final dimensions. As a result, further shaping measures are no longer required after the article emerges from the shaping device.

Also of advantage, however, are forms as claimed in claim 20 or 21, because as a result, after a certain pre-cooling of the melt stream by the additional cooling device, forming to the desired profile geometry then takes place. In addition, it is still possible in this portion for the energy introduced by the forming and reducing of the outer dimensions and the channel cross section to be removed in this portion by additional cooling elements and so a further temperature increase and possibly reduction of the same to be achieved.

The form as claimed in claim 22 is advantageous, since as a result the sliding properties of the polymer material of the melt strand passing through the channel on the following channel walls are significantly improved. In this way, a solid flow can already be achieved before the article to be produced emerges. This avoids the swelling of the polymer material that otherwise prevails in the exit area, whereby the exact profile contour or the profile cross section of the article to be produced is already established within the shaping device.

An embodiment as claimed in claim 23 is also advantageous, since as a result the expansion of the polymer material passing through becomes better possible in this transitional region by virtue of the additional introduction of the lubricant, and so a smooth transition of the polymer melt passing through to the widened, final cross-sectional shape or the cross section of the article to be produced can be achieved.

Further advantageous forms are described in claims 24 to 36. These are conducive to or instrumental in achieving the formation of a solid flow of the material passing through, in dependence on the constriction and the length of the constriction in the following portion. This avoids mutual shifts of individual layers of the polymer material for forming the article within the melt strand, whereby great dimensional accuracy of the articles to be produced can be achieved.

According to claim 27, as it passes through the shaping device, heat is constantly removed from the melt strand or strands, whereby great cooling can be achieved.

According to the form as claimed in claim 28 or 29, a better viscosity of the melt to be formed is achieved by the oscillations or vibrations introduced into the polymer melt, since the melt that has already been pre-cooled and is at a lower temperature flows better, and so the portions separated by the additional cooling device are brought together more easily within the melt. In addition, as a result the forcing of the polymer melt through the shaping device, starting from the extruder, is made easier and the forming operation is improved.

Also possible here are forms as claimed in claims 30 to 32, since as a result the sliding of the polymer melt on the walls at the regions facing the channel walls is improved or can be achieved in the first place, and as a result the polymer melt can be moved through the channel or channels in a solid flow. In addition, after the article emerges from the shaping device and has cooled down, the lubricant can form a dirt- or water-repellent protective layer or protective film for the surface of the article. Similarly, additives incorporated in the lubricant can act as filters for the radiation impinging on the article, such as UV or infrared radiation.

According to an advantageous development as claimed in claim 33, conditions conducive to the sliding on the walls, and consequently the forming of a solid flow, are additionally provided in the portion facing or opening out into the exit area. In addition, protective films for the article to be produced can also be applied along with the lubricant.

The refinement as claimed in claim 34 or 35 makes the additional formation of webs inside the hollow profile possible, these webs only being united with the profile shell to form the hollow chamber profile after a certain pre-cooling of said profile shell. This allows the individual partial flows that form the profile cross section to be better cooled or formed.

The form as claimed in claim 36 is advantageous, since as a result the material forming the webs can also be cooled, and so better mutual adjustment of the temperature profile can be achieved between the individual partial flows passing through the shaping device.

However, a form as claimed in claim 37 is also of advantage, since as a result sliding of the polymer melt on the walls, and an accompanying solid flow within the channel, can be achieved by the same or lower surface tension, in dependence on the material that is to be passed through the channel.

Embodiments as claimed in claims 38 to 40 are also advantageous furthermore, since as a result sliding on the walls of the polymer melt that is to be passed through the channel or the channels can likewise be achieved. If a coating is used, the correspondingly desired surface properties of the channel walls can be set to the widest variety of requirements and operating conditions over the longitudinal course of the channel. Application may take place for example by immersion and subsequent drying, it being possible for the application of such coatings to be performed cyclically, after each cleaning or servicing operation on the shaping device. This coating may be applied both to conventional components made of steel or iron material and to the cooling elements formed from the widest variety of materials. Sliding of the melt strand on the walls can likewise be achieved by surface structures correspondingly incorporated on the channel walls.

A form as claimed in claim 41 is also advantageous, since as a result the cooling elements are prefabricated as standard components. In this case, an injection-molding process may be used, it being possible here in a simple way to allow for the surface tension with regard to sliding on the walls by appropriate choice of the material and it also being possible for a surface structure to be included in the injection-molding process to improve sliding on the walls.

The form as claimed in claim 42 makes it possible to achieve a modular construction of the shaping device.

However, forms as claimed in claims 43 to 45 are also advantageous, since as a result it is possible to consider the formation of abrasion-resistant components with adequately great cooling in this portion of the shaping device.

In the case of the refinement as claimed in claim 46, it is of advantage that, as a result, components which are formed as one-piece components in a single operation can be created, and that they can be assembled in a modular manner to form the shaping device without any great effort being needed to join them together.

However, independently of this, the object of the invention is also achieved by a method for shaping and cooling articles, especially hollow profiles, in that, directly after it enters the shaping device, the melt strand of the polymer melt is additionally cooled within the same between the channel walls delimiting said device. The advantages obtained by this procedure are that, with the shaping device according to the invention, it is possible to dispense with a previously known form of the extrusion die for shaping the hot melt strand, and the melt strand of the polymer melt that is prepared by the extruder and enters the shaping device is cooled after the direct entry area within the channel by an additional cooling device arranged there. As a result, a great amount of heat is extracted from the polymer melt and, even after a short passage through the shaping device, the polymer melt is cooled to such an extent that forming of the cooled or pre-cooled melt strand into the desired profile geometry is still possible within the shaping device.

Independently of this, however, the object of the invention can also be achieved by the melt strand of the polymer melt being formed in a portion opening out in or facing the exit area into a cross section which corresponds to the article to be produced and by the melt strand being formed in a portion arranged directly upstream of the portion opening out in the exit area, as seen in the direction of extrusion, into a cross section that is smaller in comparison. This controlled constriction of the melt strand passing through has the effect of improving the sliding properties of the polymer material on the following channel walls and in this way achieving a solid flow even before the article to be produced emerges. As a result, a ready-shaped and dimensionally stable profile is in turn achieved in the region of the exit area of the same from the shaping device.

Further advantageous procedures are characterized in claims 49 to 77, the advantages that can be achieved thereby emerging from the detailed description.

The invention is explained in more detail below on the basis of the exemplary embodiments that are represented in the drawings, in which:

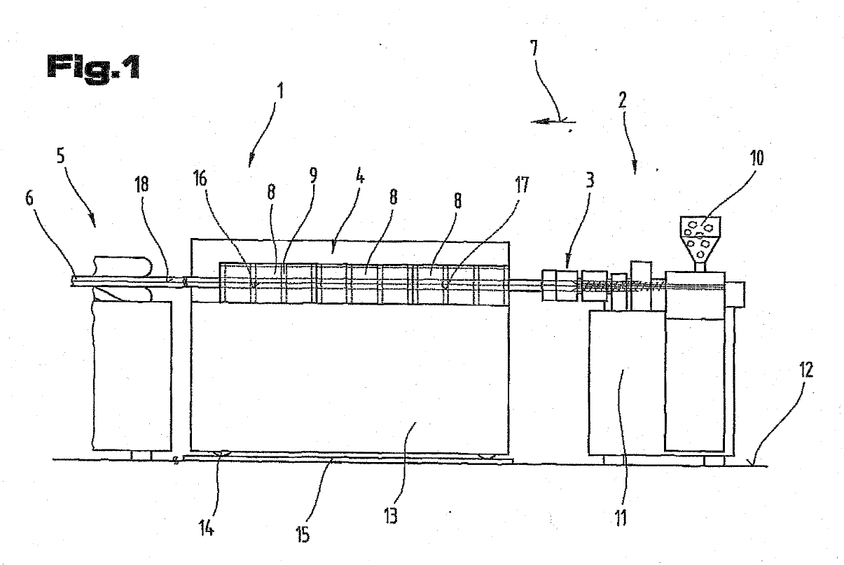

FIG. 1 shows an extrusion installation with a shaping device according to the invention, in side view and a greatly simplified representation;

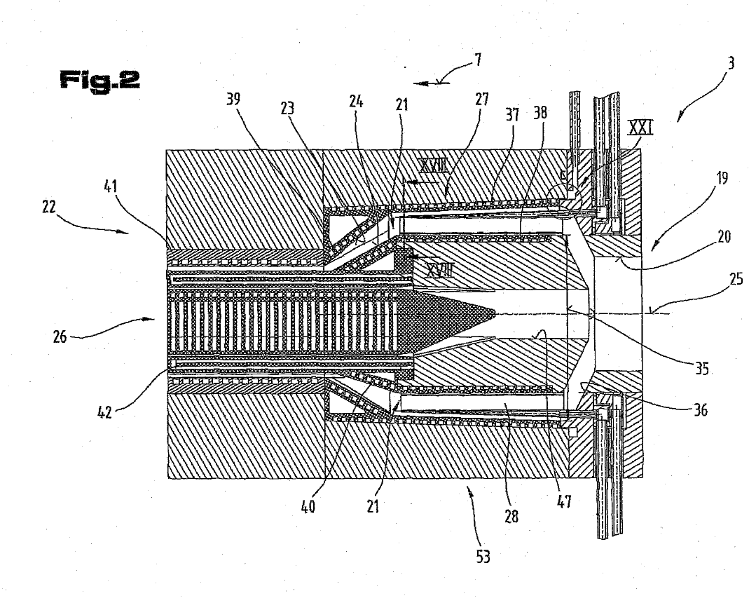

FIG. 2 shows the shaping device according to the invention, sectioned in side view and a greatly simplified representation;

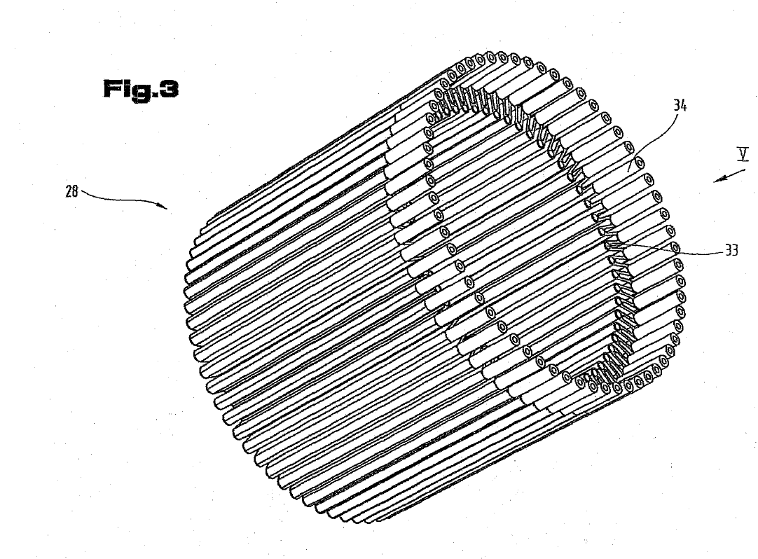

FIG. 3 shows a possible form of the additional cooling device within the channel of the shaping device, in a simplified perspective representation;

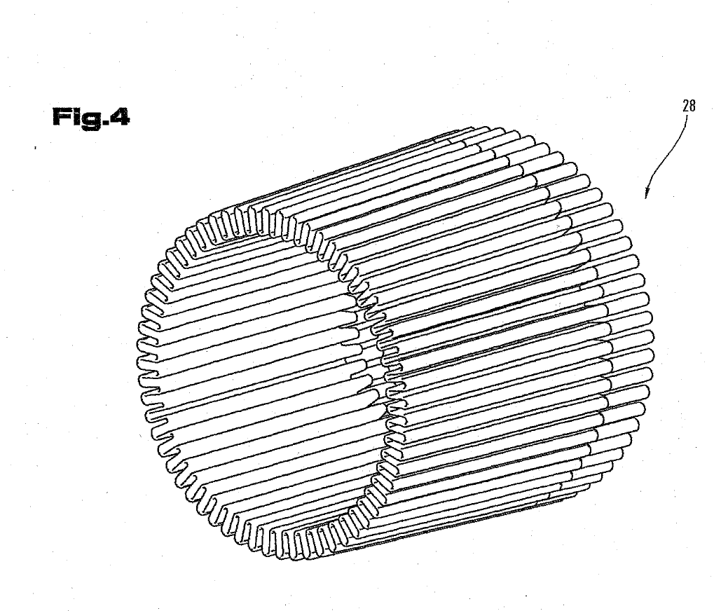

FIG. 4 shows the cooling device as shown in FIG. 3 in a further simplified perspective representation;

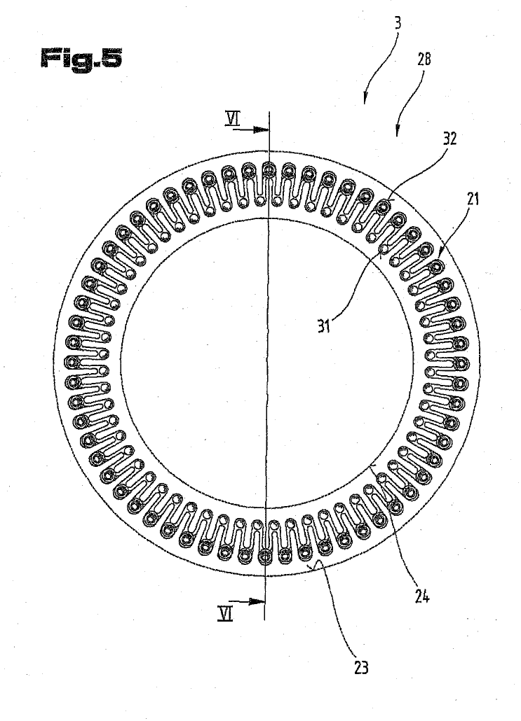

FIG. 5 shows the cooling device as shown in FIGS. 3 and 4, in an end-on view according to arrow V in FIG. 3;

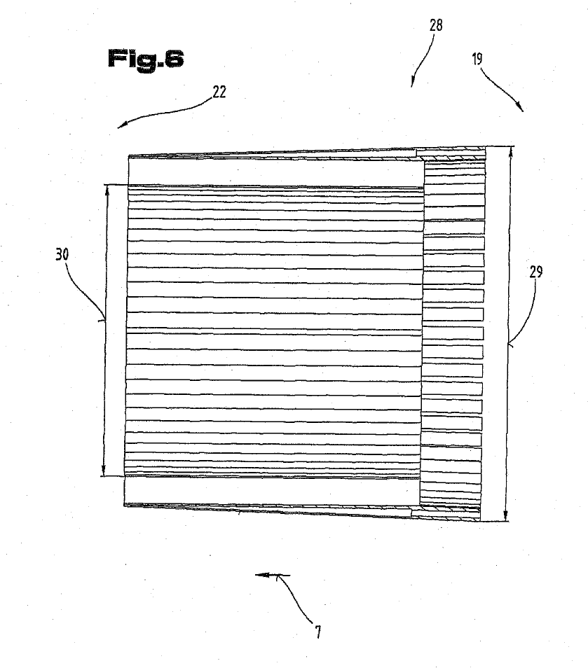

FIG. 6 shows the cooling device as shown in FIGS. 3 to 5, sectioned in side view according to lines VI-VI in FIG. 5 and a greatly simplified representation;

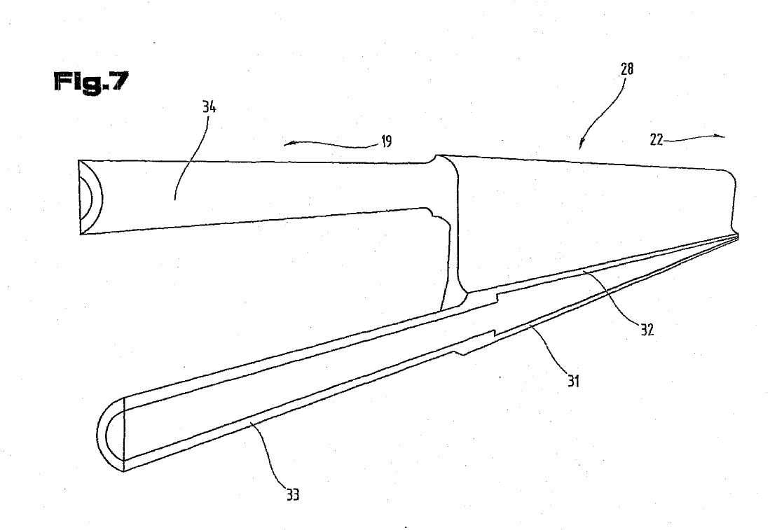

FIG. 7 shows a partial region of the cooling device as shown in FIGS. 3 to 6 in a simplified perspective representation;

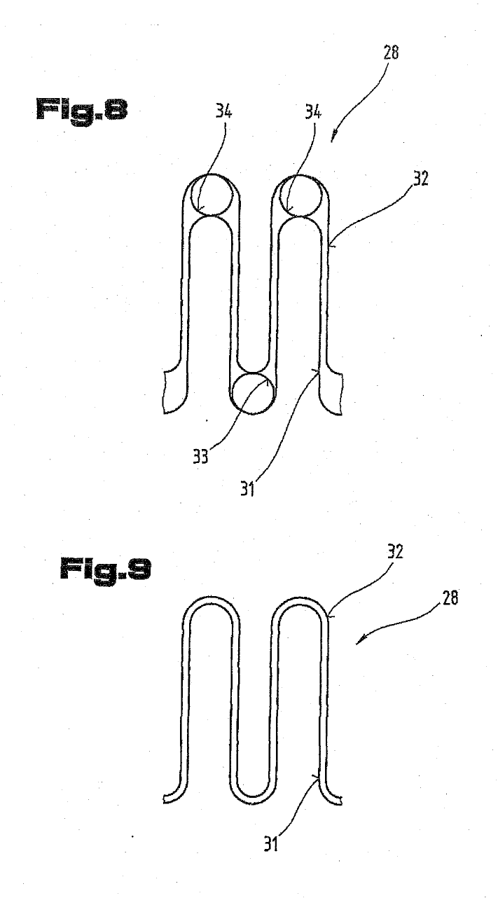

FIG. 8 shows a further partial region of the cooling device as shown in FIGS. 3 to 7 in the region of the supply and discharge lines, in elevation and a greatly simplified schematic representation;

FIG. 9 shows another partial region of the cooling device as shown in FIGS. 3 to 8 at the end facing the exit area, in elevation and a greatly simplified schematic representation;

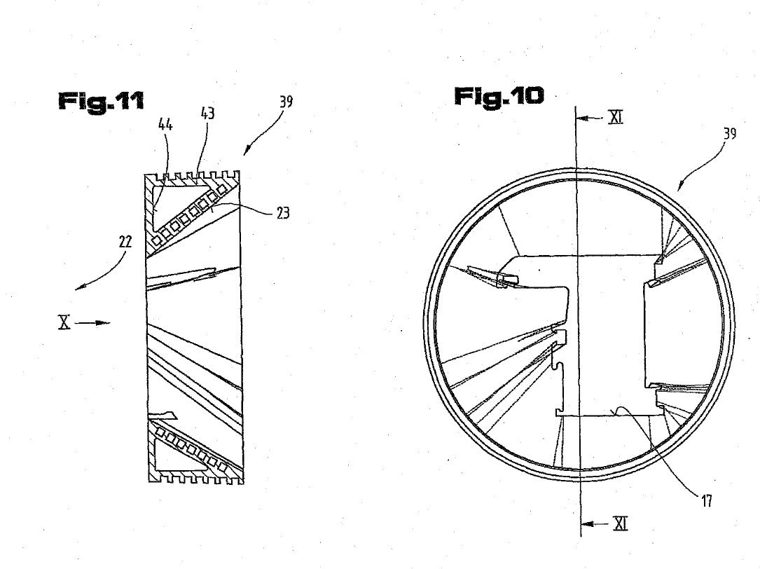

FIG. 10 shows a possible form of a cooling element in the shaping region of the shaping device according to the invention, in side view according to arrow X in FIG. 11 and a greatly simplified representation;

FIG. 11 shows the cooling element as shown in FIG. 10, sectioned in elevation according to lines XI-XI in FIG. 10 and a greatly simplified representation;

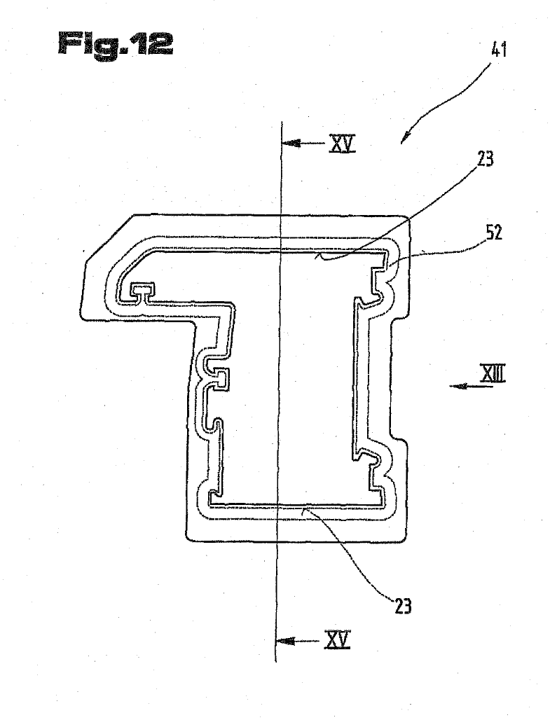

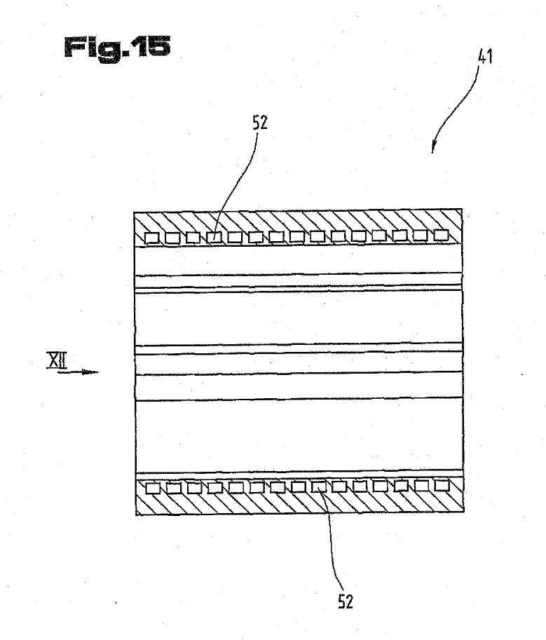

FIG. 12 shows a possible form of a further cooling element in the exit area of the shaping device according to the invention, in side view according to arrow XII in FIG. 15 and a greatly simplified representation;

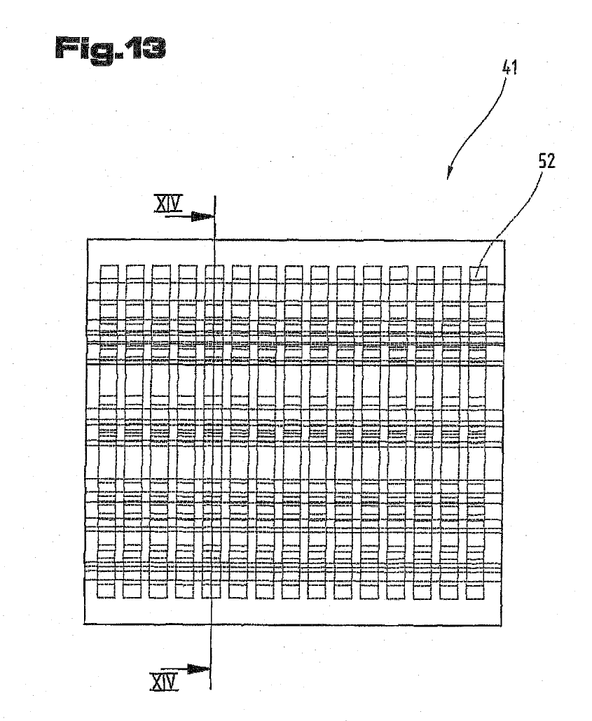

FIG. 13 shows the further cooling element as shown in FIG. 12, in elevation according to arrow XIII in FIG. 12 and a greatly simplified representation;

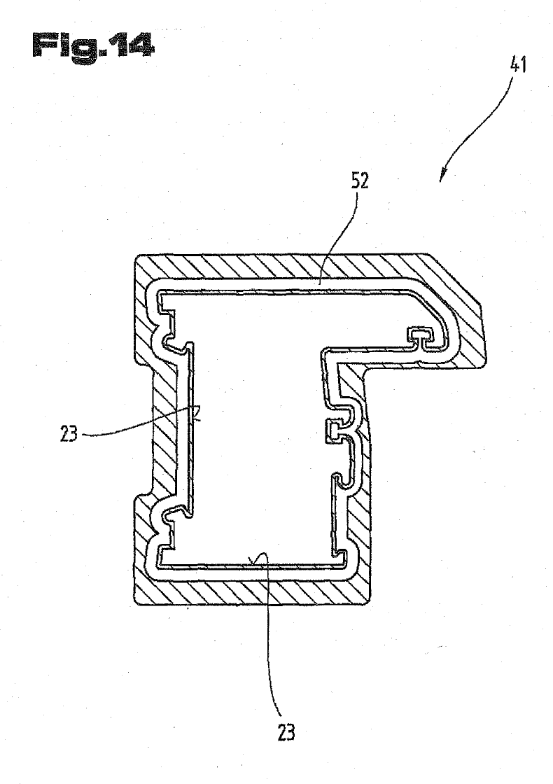

FIG. 14 shows the further cooling element as shown in FIGS. 12 and 13, sectioned in elevation according to lines XIV-XIV in FIG. 13 and a greatly simplified representation;

FIG. 15 shows the further cooling element as shown in FIGS. 12 to 15, sectioned in side view according to lines XV-XV in FIG. 12 and a greatly simplified representation;

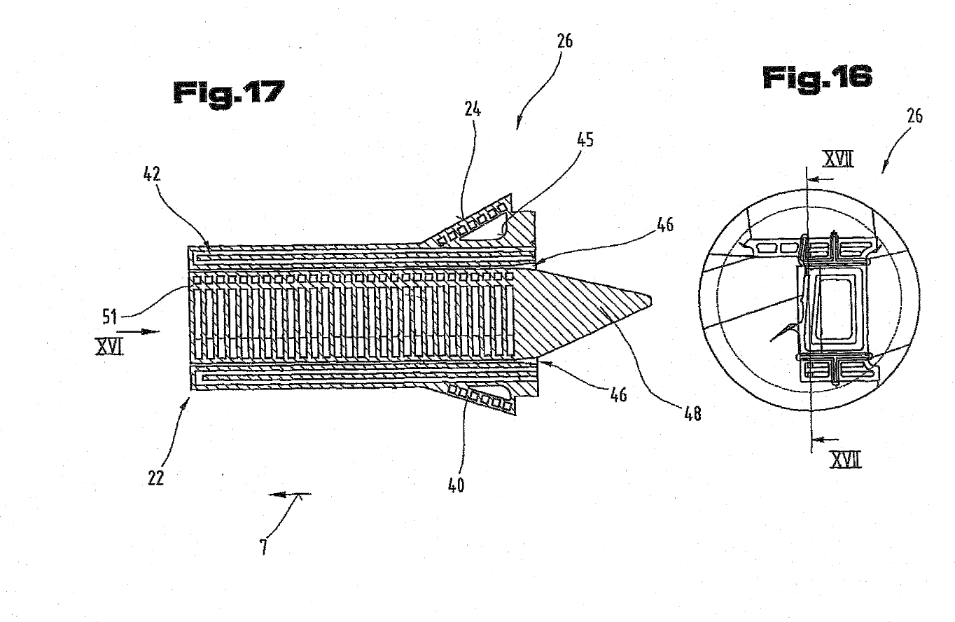

FIG. 16 shows a partial region of the mandrel in the exit area of the shaping device according to the invention, in side view according to arrow XVI in FIG. 17 and a greatly simplified representation;

FIG. 17 shows the mandrel as shown in FIG. 16, sectioned in side view according to lines XVII-XVII in FIG. 16 and a greatly simplified representation;

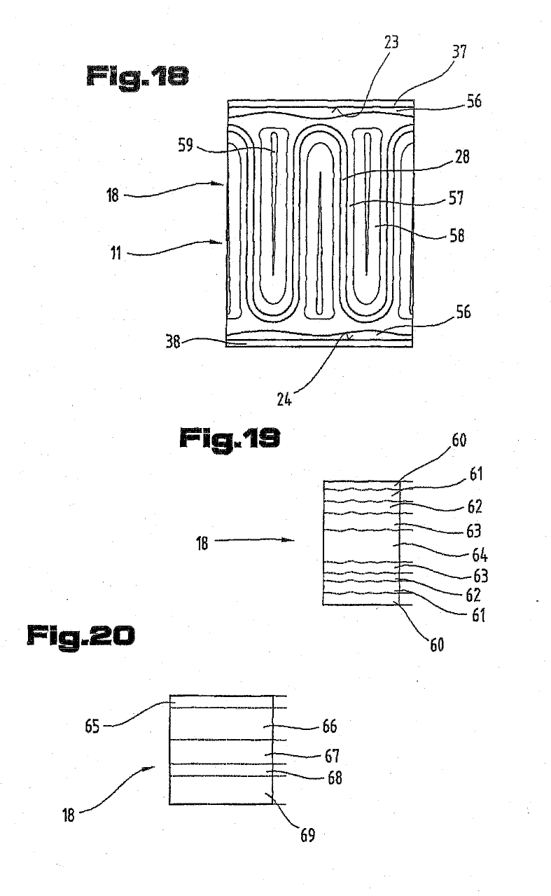

FIG. 18 shows a partial region of the melt stream within the channel at the end of the portion with the additional cooling device, in elevation and a greatly simplified representation;

FIG. 19 shows a further partial region of the melt stream at the end of the shaping device in the exit area, in elevation and a greatly simplified representation;

FIG. 20 shows a partial region of a melt stream in the case of a previously known extrusion installation with an extrusion die and dry calibration in the region of a dry calibrator, in elevation and a greatly simplified representation;

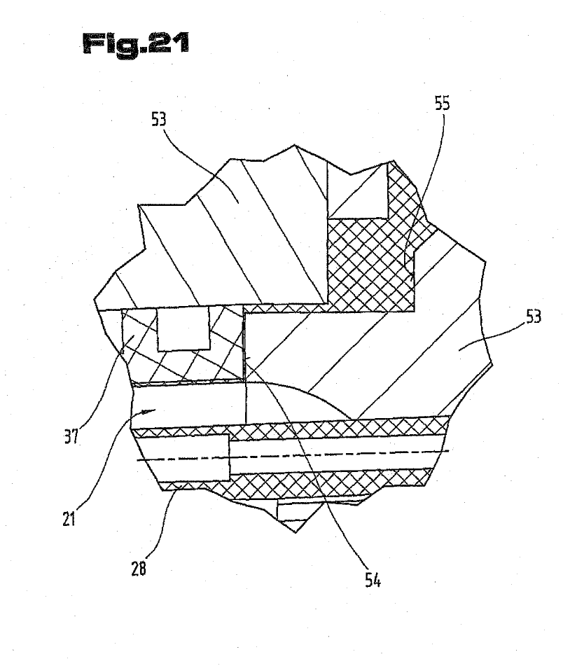

FIG. 21 shows a detail of the shaping device as shown in FIG. 2 in a greatly enlarged simplified representation according to detail XXI in FIG. 2;

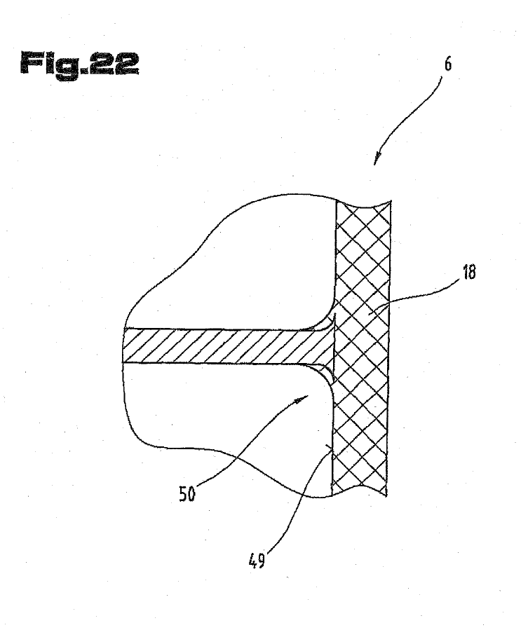

FIG. 22 shows a partial region of an article in the region where a web is connected to the profile shell, sectioned in elevation and a greatly simplified representation;

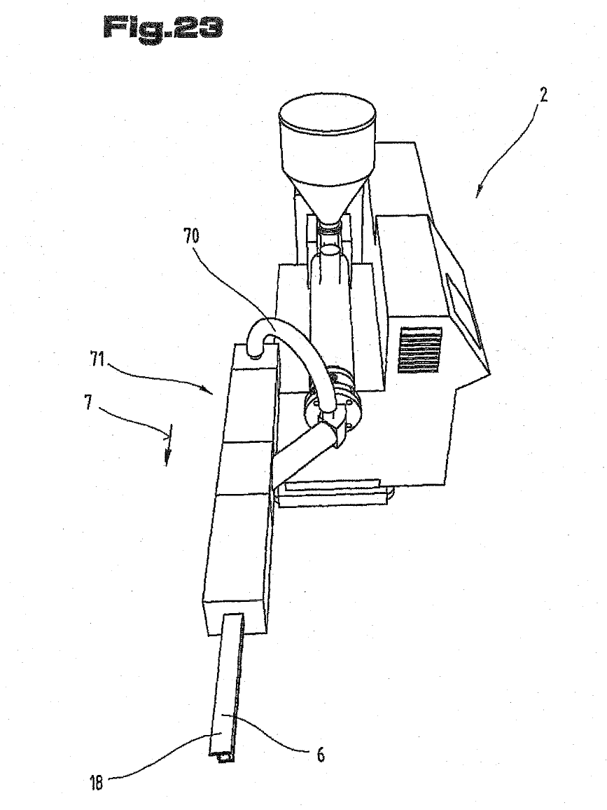

FIG. 23 shows part of an extrusion installation with an extruder and a shaping device according to the invention, in a simplified perspective representation;

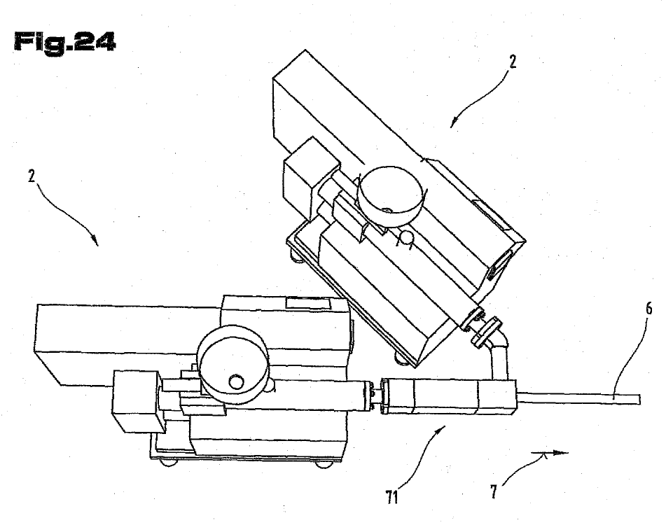

FIG. 24 shows another part of an extrusion installation with two extruders and a shaping device according to the invention, in a simplified perspective representation;

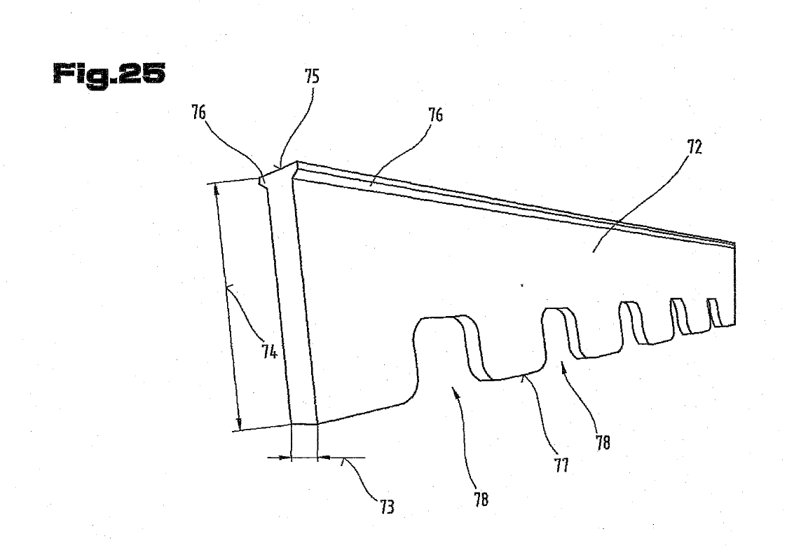

FIG. 25 shows a strip in band form as a starting aid for the extrusion operation, in a simplified perspective representation;

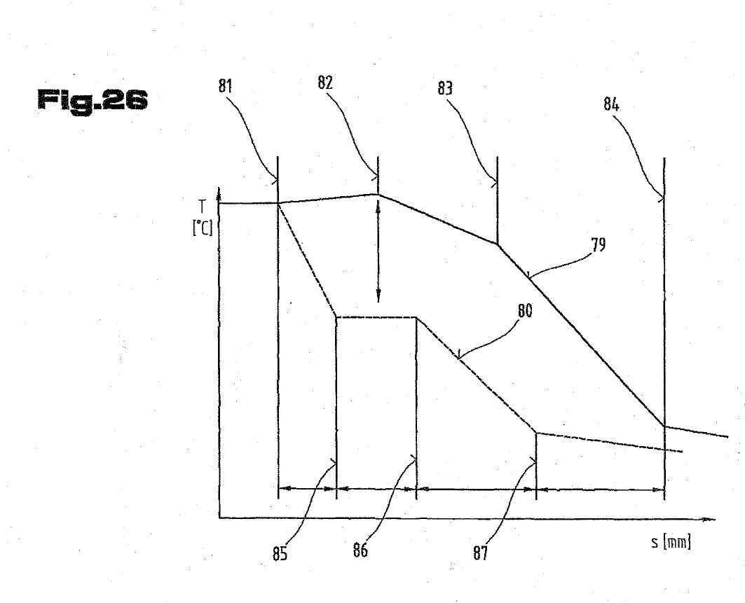

FIG. 26 shows a diagram of the temperature profile with respect to a distance, in a comparison between the known cooling profile and the cooling profile according to the invention;

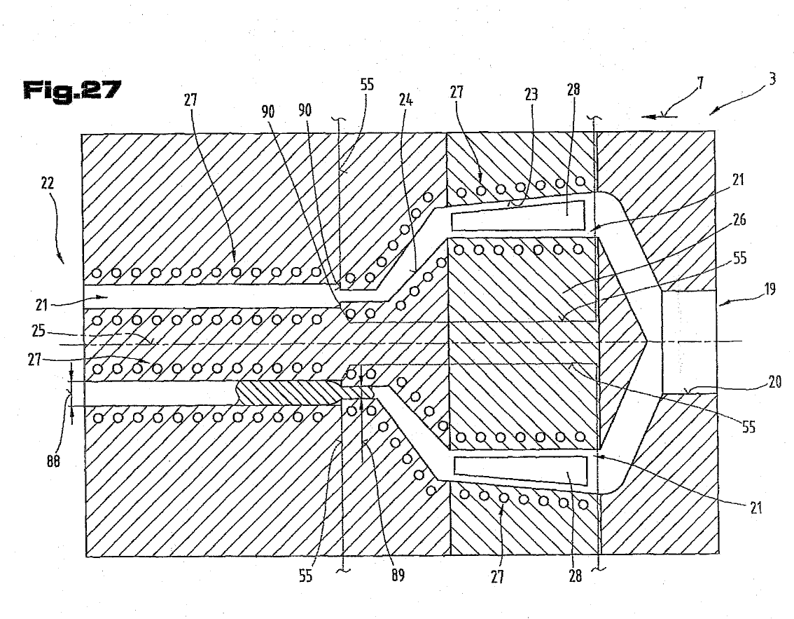

FIG. 27 shows a further possible embodiment of a shaping device, sectioned in side view and a greatly simplified schematic representation;

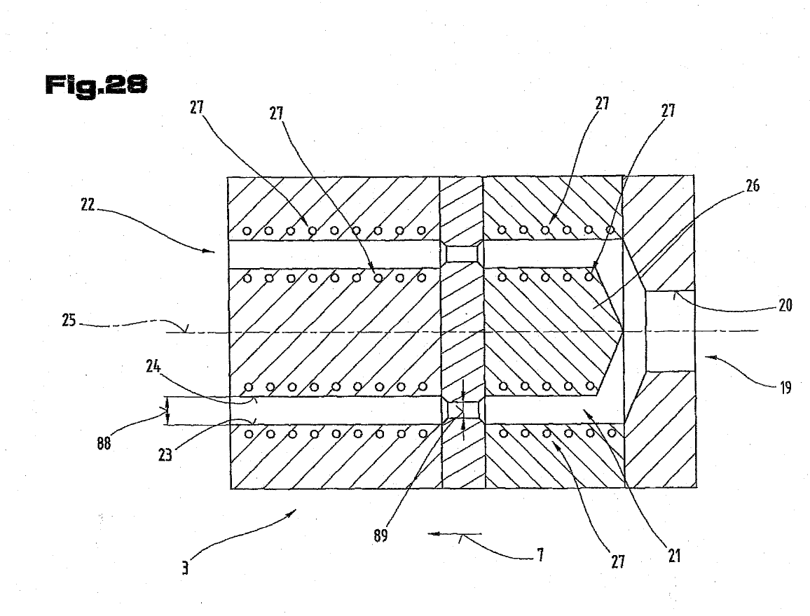

FIG. 28 shows another possible form of a shaping device, sectioned in side view and a greatly simplified schematic representation.

It should be stated by way of introduction that, in the embodiments variously described, the same parts are provided with the same reference numerals or with the same component designations, the disclosures that are contained in the overall description being transferable analogously to the same parts with the same reference numerals or the same component designations. The positional indications that are chosen in the description, such as for example upper, lower, lateral etc., also relate to the figure that is being described or represented in a particular instance and, in the event of a change in position, can be transferred analogously to the new position. Furthermore, individual features or combinations of features from the various exemplary embodiments shown and described can also represent solutions that are in themselves independent, inventive or according to the invention.

Shown in FIG. 1 is an extrusion installation 1, which comprises an extruder 2, a shaping device 3 arranged downstream of said extruder, a cooling device 4 arranged downstream of said shaping device and possibly a caterpillar takeoff 5, or just a takeoff assisting device, for an extruded article 6. The caterpillar takeoff 5 or the takeoff assisting device serves the purpose of drawing the article 6, for example a hollow profile, especially a hollow chamber profile, of plastic for window and/or door construction, off in the direction of extrusion 7 from the shaping device 3 or possibly from the extruder 2, through the cooling device 4, or possibly just for exerting a small drawing-off force, dependent on the profile cross section, on the article 6. This article 6 may, however, also be formed by a so-called solid profile, which can likewise be produced with the shaping device 3 according to the invention.

In the case of this exemplary embodiment, the shaping device 3 comprises a unit which is arranged directly downstream of the extruder 2 and in which the melt strand entering is simultaneously cooled and thereby formed into the desired or predetermined profile geometry, and leaves the shaping device 3 as a virtually dimensionally stable article 6. The shaping device 3 is described in detail in relation to the figures that follow.

The article 6 that emerges from the shaping device 3, and is to this extent dimensionally stable at least in its shell region, is cooled in the downstream cooling device 4 to the extent that the interior space or its inner chambers is/are also correspondingly cooled. After leaving the cooling device 4, the temperature of the profile over its entire cross section is around customary room temperature, such as for example about 15° C. to 25° C. The cooling device 4 may be formed by a negative pressure tank 8, or with preference however a number of negative pressure tanks 8, in which a number of calibrating plates 9 may be arranged. However, some of the calibrating plates 9 may also be formed just to provide a supporting function, as supporting plates for the article 6. In order to avoid unnecessary repetition, reference is made to the applicant's DE 195 04 981 A1 as an example of a negative pressure tank 8 formed in such a way.

It would also be possible, however, to use just a spray tank known from the general state of the art. This spray tank has the advantage over the negative pressure tank formed as a water tank that the cooling medium, in particular water, is only sprayed onto the article 6. This eliminates the buoyancy force of the profile in the cooling bath that otherwise acts, and the article no longer needs to be guided by supporting plates within the spray tank. A pressure that is lower than ambient pressure—that is to say a negative pressure—can build up in the space inside the spray tank.

In the region of the extruder 2 there is a receiving container 10, in which a material, such as for example a compound or granules for forming a plastic, is stored, which material is fed by at least one conveying screw in the extruder 2 to the shaping device 3. Furthermore, the extruder 2 also comprises a plasticating unit, which, by means of the conveying screw and possible additional heating devices, has the effect while the material is passing through it that the material is heated, plasticated, and thereby adequately prepared in accordance with the properties inherent in it, under pressure and possibly with heat being supplied, and is conveyed in the direction of the shaping device 3. Within the shaping device 3, the melt stream of the plasticated material is guided or formed into the desired profile cross section in transitional zones.

In the case of previously known installations, an extrusion die or a heated profile die was arranged at the extruder 2, which die formed the melt strand entering it into the profile geometry while heat was retained or supplied. In calibrating dies following thereafter, this preformed plastic melt strand was then cooled in a known way to correspond to the desired profile geometry and thereby established in its final form. In this case, the calibrating die or dies were able to follow on directly after the extrusion die, so that the melt pressure built up in the extrusion die transmitted itself into the calibrating die.

The shaping device 3, the plasticating unit and the receiving container 10 are supported or mounted on a machine bed 11, the machine bed 11 being erected on a level standing area 12, such as for example a level factory floor.

In the case of this exemplary embodiment, the entire cooling device 4 and supply devices (not represented any more specifically) for the shaping device 3 are arranged or mounted on a calibrating table 13, the calibrating table 13 being supported by means of running rollers 14 on one or more running rails 15 fastened on the standing area 12. This mounting of the calibrating table 13 by means of the running rollers 14 on the running rails 15 serves the purpose of allowing the entire calibrating table 13 with the devices arranged on it to be displaced in the direction of extrusion 7—according to the arrow indicated—from or to the shaping device 3. In order to allow this adjusting movement to be carried out more easily and accurately, the calibrating table 13 is assigned for example a displacement drive (not represented any more specifically), which permits a targeted and controlled longitudinal movement of the calibrating table 13 toward the extruder 2 or away from the extruder 2. Any ways and means known from the prior art can be used for driving and controlling this displacement drive.

The forming and calibrating are performed here exclusively by a completely dry calibration. Furthermore, it may also be advantageous to completely prevent any access of ambient air between the shaping device 3 and the first cooling chamber of the cooling device 4.

The negative pressure tank 14 to 16 may have for the article 6 emerging from the shaping device 3 at least one cooling chamber, which is formed by a housing (represented in a simplified manner) and is subdivided into regions directly following one another by the calibrating plates 9 arranged in the interior space and represented in a simplified manner. For rapid heat removal from the article 6, the space inside the cooling chamber is at least partially filled with a cooling medium, it being possible for the cooling medium to be both liquid and gaseous. It goes without saying, however, that the same cooling medium may also be present in the cooling chamber in different states of aggregation. However, it is also additionally possible to lower the pressure in the space inside the cooling chamber to a pressure that is lower than atmospheric air pressure.

After emerging from the shaping device 3, the article 6 has a cross-sectional form that is predetermined by said device and is dimensionally stable, which is further cooled in the then following cooling device 4 until the residual heat contained within the article 6 is also removed from it.

For the operation of the extrusion installation 1, in particular the devices arranged or mounted on the calibrating table 13, the latter can be connected to a supply device (not represented any more specifically), by which the widest variety of units can be subjected for example to a liquid cooling medium, to electrical energy, to compressed air and to a vacuum. The widest variety of energy sources can be freely chosen and used according to requirements.

For guiding the article 6 through the individual calibrating plates 9, they have at least one calibrating opening 16 or an aperture, individual forming areas of the calibrating opening 16 delimiting or bounding, at least in certain regions, an outer profile cross section 17 of the article 6 that can be guided through. As already previously described, the article 6 is cooled, at least in the region of its outer profile shell 18, while it passes through the shaping device 3, and the softened polymer material thereby solidifies, to the extent that the outer profile sections of the hollow profile already have a certain intrinsic rigidity or strength. In order to be able to remove the residual heat that is still present in the space inside the profile, in particular in the region of the hollow chambers and the webs arranged therein, completely from the article 6, in the case of this exemplary embodiment the cooling device 4 is provided.

In FIGS. 2 to 22, the shaping device 3, or the individual parts that form it, is/are represented and described in more detail. For instance, the shaping device 3 has in an entry area 19 that is facing, or can be made to face, the extruder 2 an inlet opening 20 for the prepared polymer melt exiting from the extruder 2, which opening is not represented any more specifically here. Furthermore, at least one channel 21 extends from the entry area 19 within the shaping device 3 in the direction of an exit area 22. The channel or channels 21 is/are delimited by outer and inner channel walls 23, 24 that are represented here in a simplified manner. Arranged at a center 25 schematically represented by a center line is a mandrel 26, which at least in certain regions forms portions of the channel walls 24. In this case, the mandrel 26 may be formed by one component or by a number of components. Furthermore at least some of the channel walls 23, 24 may be assigned a cooling device 27 for them.

An additional cooling device 28 for the polymer melt that is to be passed through is arranged within the channel 21 in the region directly adjacent the entry area 19. In the case of this exemplary embodiment, this additional cooling device 28 serves for extracting a great amount of heat from the polymer melt directly after it enters the shaping device 3, with preference in those channels 21 that are provided for forming the profile shell 18 of the hollow profile.

When a commercially available PVC (polyvinyl chloride) compound is used, the exiting polymer melt is at about 200° C. when it leaves the extruder. After the polymer melt passes through the portion of the channel 21 in which the additional cooling device 28 is arranged, cooled outer regions are already at a temperature of between 80° C. and about 120 to 130° C. The end of the additional cooling device 28, as seen in the direction of extrusion 7, in this case lies about halfway along the longitudinal extent of the entire shaping device 3.

As can now be seen better by viewing FIGS. 3 to 9 together, the additional cooling device 28 has an approximately wavy or sinuous shape, when seen in the direction of extrusion 7. As a result, a large surface area is achieved within very small spaces, whereby the cooling effect of the additional cooling device 28 within the melt strand is significantly increased and improved. In FIG. 5, the additional cooling device 28 is represented as seen in the direction of extrusion 7, the outer and inner channel walls 23, 24 that bound the channel 21 also being represented by dashed lines. It can also be seen from this that the outer delimitation of the additional cooling device 28 is arranged within the channel 21 at a distance from the channel walls 23, 24.

As a result, when the melt strand of the polymer melt to be cooled is passed through, it is divided up in a sinuous form in the region of the additional cooling devices, the partial streams of the melt strand that are facing the two channel walls 23, 24 being formed continuously, and consequently uninterruptedly, over their cross sections during the inner cooling of said strand. Only the interior of the melt strand is broken up or interrupted by the cooling device 28 that is formed here in a sinuous or wavy manner, whereby rapid cooling can take place in the interior of the melt strand. This rapid cooling of the viscous melt strand allows what is known as sliding on the channel walls 23, 24 bounding the channel 21 to be already achieved.

In addition, however, it would also be possible for portions of the channel walls 23, 24 delimiting the channel 21 to be formed at least in certain regions from a material of a surface tension that is the same as or less than that of the polymer melt to be passed through the channel 21. The sliding on the walls is dependent on several factors, only the temperature difference between the melt strand and the channel walls 23, 24 and the surface tension of the materials that come into contact (melt strand/channel wall) being mentioned here as examples.

For example, the surface tension of a PVC melt is about 37 mN/m to 70 mN/m. Previously used tool steel has a surface tension of about 2500 mN/m. In order to achieve sliding on the walls, a value of the surface tension that is the same as or less than that surface tension of the melt or the melt strand to be passed through must therefore be chosen. In this case, values of around 20 mN/m and less have proven to be favorable here. As an example of a material for forming the channel walls 23, 24, mention should be made here of PEEK (polyetherether ketone), which is highly heat-resistant and in which additional reinforcing fibers may also be incorporated. This material has, for example, a surface tension of 12 mN/m. This sliding on the walls is desired in order to lower the pressures in the shaping device and achieve what is known as a solid flow of the material to be passed through, whereby swelling of the profile cross section in the exit area 22 is subsequently prevented. In this case, the melt strand can be passed through not only in the region of its interior cooling but also thereafter, for example in that portion of the channel 21 which opens out in or is facing the exit area 22.

In the representation of FIG. 6 it is also shown that the additional cooling device 28 has over its longitudinal extent in the direction of extrusion 7 a decreasing outer dimension 29 in the direction perpendicular to the direction of extrusion 7. In the case of this exemplary embodiment, this cooling device 28 has an inner dimension 30 that runs approximately cylindrically, and consequently parallel to the center 25.

The additional cooling device 28 may be formed by two components which are of a wave form in relation to each other and are pushed one into the other, and which form in the regions facing one another a receiving space for a cooling medium (not represented any more specifically here). The end of the cooling device 28 that is facing the exit area 22 is in this case closed off in a sealing manner, as is the end facing the entry area 19, as represented in a simplified manner in FIGS. 9 and 8, respectively. In this case, a first inner part 31 for forming the cooling device 38 is formed in a parallel manner both in the region facing the outer channel wall 23 and in the region facing the inner channel wall 24. A further outer part 32 of the cooling device 28 is formed in a manner tapering conically from the entry area 19 to the exit area 22 both in the region facing the outer channel wall 23 and in the region facing the inner channel wall 24. This provides the possibility of arranging respectively at each wave trough and wave crest in the region of the cooling device 28 that is facing the entry area 19 supply and discharge lines 33, 34, which are only represented in a simplified form here and of which only the discharge lines 34 arranged in the outer circumference are represented in FIG. 3. These are connected to supply lines—FIG. 7—within the shaping device 3 that are represented in a correspondingly simplified form and make it possible for them to supply the cooling device 38 with a cooling medium. In this case, the cooling medium can be made to pass through in a closed circulation via the supply discharge lines 33, 34. On account of the great amount of heat removal, at least one cooler for the cooling medium is provided in this closed circulation, a corresponding conveying device additionally having to be provided. The supply and discharge lines 33, 34 are only represented by way of example, the supply line being disposed closer to the center 25 and the discharge line 34 at a greater distance from it. However, it would be possible to change the two lines over.

In order to make it possible for the cooling medium to flow through between the wall parts of the cooling device 28 that are directly adjacent or lie against one another, corresponding depressions and/or elevations are to be respectively provided on their mutually facing sides, in order in this way to form flow channels for a forced throughflow. In this case, the mutually facing flow channels are to be configured such that they cross one another, in order to be certain to avoid blocking of the same when they lie one against the other.

As can now in turn be seen better from FIG. 2, the channel 21 has over its longitudinal extent a differing longitudinal course, with respect to the center 25, between the entry area 19 and the exit area 22. In addition, the channel 21 has over its longitudinal extent a differing cross-sectional dimension, in particular a decreasing and/or increasing cross section, between the entry area 19 and the exit area 22.

A portion of the mandrel 26 in the region of the additional cooling device 28 has in relation to the inlet opening 20 arranged in the entry area 19 an outer dimension 35 that is larger in comparison. As a result, the melt strand entering the inlet opening 20 is conically enlarged, and consequently widened, in its cross-sectional dimension by a manifold 36 following the inlet opening 20, by virtue of the greater outer dimension 35 of the mandrel 22, and after flowing through the manifold 26 flows into the portion of the channel 21 in which the additional cooling device 28 is arranged.

In the region of the additional cooling device 28, heat is extracted from the melt stream sliding along the two channel walls 23, 24 by at least one cooling element 37, 38 of the cooling device 27 arranged within the shaping device, and consequently is also cooled here. These two cooling elements 37, 38 may be formed for example by the previously described, highly heat-resistant plastics material PEEK, in order in this way to achieve sliding on the walls.

To simplify production or fabrication, the channel 21 may have in the region of the additional cooling device 28 an annular channel cross section in a plane aligned perpendicularly in relation to the direction of extrusion 7. However, other cross-sectional forms would also be possible for the channel 21, such as for example square, rectangular, oval, polygonal etc. The outer channel wall 23, delimiting the channel 21 in the region of the additional cooling device 28, may be formed such that it tapers over its longitudinal extent, with respect to the center 25, from the entry area 19 to the exit area 22. In the case of this exemplary embodiment, the inner channel wall 24, delimiting the channel 21 in the region of the additional cooling device 28, is formed in a cylindrical or parallel-running manner over its longitudinal extent, with respect to the center 25. As a result, while it is passing through this portion of the channel 21 in the region of the additional cooling device 28, the melt stream is formed such that it decreases in its cross-sectional dimension, and is consequently pressed together.

A portion of the channel 21 in the region of the exit area 22 corresponds in its cross section, or the cross-sectional dimensions, to the cross section to be formed of the article 6 that is to be produced, especially a hollow profile. In this case, this portion of the channel 21 is formed in its longitudinal extent parallel to the direction of extrusion 7 or the center 25, in a manner corresponding to the profile contour.

Arranged between the previously described portion of the channel 21 with the additional cooling device 28 and the last-described parallel-aligned portion of the channel 21 in the exit area 22 is a further portion with a decreasing cross section, or decreasing dimension, with respect to the center 25, as indicated in approximately half of the shaping device 3. In this case, as already previously described, the melt strand or melt stream passing through the channel 21 is cooled in the portion of the additional cooling device 28 and is formed into the desired profile geometry in the further portion following thereafter, the cross section of the channel 21 at the end of this further portion corresponding virtually to the profile geometry of the hollow profile that is to be produced. However, it would also be possible independently of this to form the further portion of the channel 21 not with a decreasing dimension or a decreasing cross section but with an increased cross section or dimension in relation to the portion with the additional cooling 28.

In this case, to form the profile shell 18, after the interior cooling, the melt strand that has been additionally cooled in its interior is formed into the profile cross section that is to be produced by increasing its outer dimension. This is not represented more specifically however.

As can be seen from the representation of FIG. 2, in the case of this exemplary embodiment all the portions of the channel 21 for forming the profile shell 18 are assigned, at least in certain regions but with preference continuously, cooling elements 37 to 42 of the cooling device 27, or they form these cooling elements.

To facilitate the previously described forming of the already cooled melt strand directly after the portion of the channel 21 with the cooling element 28, it is advantageous that at least some of the channel walls 23, 24 are assigned at least one oscillation generator in this further portion of the channel 21. This allows the melt strand to be treated with oscillations or vibrations while it passes through the shaping device 3, whereby the forming in this region to the profile geometry that is to be produced is additionally facilitated. This treatment with oscillations or vibrations is to be carried out after the additional interior cooling.

As already previously described, while it passes through the channel 21 in the region of the exit area 22, the melt strand that has been cooled in certain regions is finally formed in the portion thereof concerned into the cross section to be formed of the hollow profile that is to be produced and is solidified such that it already emerges from the shaping device 3 as a dimensionally stable article 6. As previously described, to simplify the production or fabrication of individual parts of the shaping device 3, it is formed with preference in a rotationally symmetrical manner, with respect to the center 25, from the entry area 19 up to the end of the portion of the channel 21 with the cooling device 28 arranged in it. In this case, for example, the two cooling elements 37, 38 in this portion may be produced as simple injection-molded parts. This portion of the shaping device 3 may then be formed as a standard part that is to be fabricated independently of the profile geometry to be formed, allowance having to be made here for the level of melt throughput and the amount of polymer melt required for forming the profile geometry. This allows differing sizes with respect to the cross section or outer dimension to be used as standard.

In FIGS. 10 and 11, one possible way of forming the cooling element 39 with the channel wall 23 delimiting the channel 21 in the region of its outer side is represented in a simplified form, this cooling element 39 also serving at the same time as a directing device within the shaping device 3, in the forming region. At the end facing the exit area 22, this cooling element 39 has an exterior outline of the profile cross section 17, as can best be seen from FIG. 10. In this respect it should be mentioned that this profile cross section shown here has only been chosen by way of an example of many possible profile cross sections. In this case, the transformation or forming is performed from an annular cross-sectional area of the melt strand to the desired profile cross section. The annular cross-sectional area described here may, however, also be of any other desired cross-sectional form.

On account of the outer dimension here of a round form, as seen in the direction of extrusion 7, and the previously described decreasing channel cross section in the region of the channel wall 23 to the profile cross section 17, an approximately triangular wall part 43 forms in a perpendicular direction, as seen in the direction of extrusion 7—that is to say in its longitudinal section—which wall part may have a peripheral hollow space 44 in its interior.

As already previously described, the oscillation generator for treating the already cooled melt stream that is to be formed is arranged in this portion of the channel 21, in order to be able to carry out this forming more easily. If the hollow space 44 is subjected for example to an appropriate pressure medium, which is supplied for example by means of a multi-piston pump, pressure peaks are produced in the medium according to the number of strokes per unit of time, these pressure peaks inducing oscillation or vibration of the channel walls 23. For the sake of better overall clarity, supply and discharge lines necessary for this, or the corresponding devices, have not been represented in detail.

Shown in FIGS. 16 and 17 is part of the mandrel 26 of the shaping device 3 which extends into the shaping device 3 from the exit area 22 in the direction of the entry area 19. The inner channel wall 24, running obliquely in relation to the direction of extrusion 7, of the portion delimiting the channel 21 forms both the previously described cooling element 40 and possibly a further oscillation generator for the inner channel wall 24. For this purpose, a hollow space 45, with preference a peripheral space, of the channel wall 24 is provided in turn directly adjacent in the mandrel 26, which hollow space can, as already previously described, be subjected to a pulsating heating pressure medium to generate oscillation. However, it would also be possible to generate the oscillations by electromagnetic means or the like. The frequency of the oscillations is in this case dependent on the material of the polymer melt passing through, the degree of cooling of the same and the energy thereby generated, which is introduced into the polymer melt as frictional energy and is thereby conducive to the forming and bonding operation on the previously broken-up interior of the melt strand in the region of the additional cooling device 28. To save material, it may be advantageous for the interior of the mandrel 26 that is represented in FIGS. 16, 17 to be formed such that it is hollow, at least in certain regions.

The longitudinal course of the channel 21, described in detail above, serves for forming the profile shell 18 of the hollow profile. Usually, however, the hollow profile has in its interior at least one web, with preference a number of webs. For forming the same, the mandrel 26 has at least one further channel 46, to form the same within the hollow profile.

As can now in turn be better seen from FIG. 2, the pre-cooled melt strand forming the profile shell 18 within the channel 21 is passed through the shaping device 3. Part of the mandrel 26 has in the region facing the entry area 19 an inflow opening 47 for forming the webs inside the hollow profile and thus for forming a hollow chamber profile. The portion of the mandrel 26 previously described in relation to FIGS. 16 and 17 has in the region facing the entry area 19 a conically formed end 48, which transfers the melt stream delivered by the inflow opening 47 to the respective further channels 46 formed within the mandrel 26. To unify the channel 21 for forming the profile shell 18 and the further channel or channels 46 for forming the webs, they are brought together here at the end of the further portion formed between the portion of the channel 21 with the additional cooling device 28 and the portion of the channel 21 in the exit area 22, at the mutually facing outer regions.

This makes it possible first to cool and form adequately those portions of the overall melt stream that are intended for forming the profile shell 18, and only after that unite them within the shaping device 3 with the webs arranged inside the profile shell 18.

One possible form of the connection of a web to the profile shell 18 is represented in a simplified form in FIG. 22. Thus, the profile shell 18 has a greater wall thickness than the web. In the region where the web is connected to an inner wall 49 of the profile shell 18, the latter has a cross-sectional enlargement, for example in the form of a dovetail. To avoid points of weakness within the profile shell 18, the web is intended to end approximately in the region of an inner wall 49. Extending from the inner wall 49 in the direction of the web, the profile shell 18 has a transitional region 50, which is in engagement with the dovetail-shaped web after forming. However, it would also be possible to provide other positive connections instead of the dovetail connection, such as for example apertures, ribs or the like. If adequate heat to bond the outer regions of the webs to the inner wall 49 of the profile shell 18 is still present, a conventionally used form of connection can be provided between the web and the profile shell 18.

For cooling the webs within the mandrel 26, the latter may be assigned further cooling elements 51, in order to be able also to cool this polymer melt appropriately. In this case, these cooling elements 51 may also be arranged on both sides of the channels 46 or else peripherally in relation to them.

Shown in FIGS. 12 to 15 is one possible form of the cooling element 41, which extends from the exit area 22 in the direction of the entry area 19 into the shaping device 3. With its previously described channel walls 23, this cooling element 41 delimits the channel 21 to form the profile shell 18 in its outer circumferential region. Represented inside the cooling element 41 are simplified cooling channels 52, which may be formed in a wide variety of ways from the general state of the art. With preference, the cooling channel or channels 52 are outwardly arranged peripherally over the profile cross section 17 of the article 6 to be cooled, it also being possible for them to be arranged spirally over the longitudinal course in the direction of extrusion 7. For the sake of better overall clarity, the appropriate supply and discharge lines have not been represented or described in detail.

This cooling element 41 and also the previously already described further cooling elements 37, 38 and 39 may also represent what are known as insert elements in a basic body 53 forming the shaping device 3. This makes it possible to form the cooling elements 37 to 42 and the mandrel 26 from different materials, it being possible for the material that is suited for the purpose to be used at each point within the channels 21, 46. It is thus possible to consider the already previously described sliding on the walls, adequate abrasion resistance and further requirements. For example, the mandrel 26, extending from the exit area 22 to the entry area 19, or a portion of the mandrel, and possibly the cooling elements 39, 41 may be formed from a ceramic material. This ceramic material has a high resistance to wear. However, it would also be possible to produce the previously described cooling elements also from special alloys, plastics or polymer compounds.

It can be seen by viewing FIGS. 2 and 21 together that, at the beginning of the portion of the channel 21 in which the additional cooling device 28 is arranged, a manifold 55 (represented in a simplified form) opens out into the channel 21 between the basic body 53 and the cooling element 37 inserted into the basic body 53 of the shaping device 3, at the end region 54 of said cooling element that is facing the entry area 19. In the case of this exemplary embodiment, this manifold 55 or supply line is assigned to the outer channel wall 23 of the channel 21 and serves for supplying a lubricant. However, it would also be possible also to assign the inner channel wall 24 and the channels 46 for forming the webs a further manifold 55 for supplying the lubricant. This lubricant is intended primarily to serve to assist or ensure the sliding on the walls of the polymer melt passing through the channel 21, and possibly the channel 46, during its cooling until there forms a solid flow. Waxes or oils that are in a flowable state of aggregation at temperatures of such a level may be used as lubricants. These waxes and oils are also already incorporated in certain PVC compounds and serve there likewise to assist sliding. These lubricants that are used may also serve the purpose of remaining as a protective layer adhering to the profile after cooling, in order to surround the profile with a thin water- or dirt-repellent film. Furthermore, these lubricants may also contain additives which can act as a filter for the widest variety of radiation, such as for example UV radiation, infrared radiation, etc. In addition; however, it would also be possible with this protective layer to achieve what is known as a lotus effect, in order to prevent or hinder dirt particles or water from adhering, and possibly also achieve a self-cleaning effect.

The previously described manifold 55 may be formed continuously over the entire outer circumference of the channel or profile cross section 17. This also applies to the further manifold 55 in the region of the inner channel walls 24 and of the channel walls delimiting the channel 46 or the channels 46.

In FIG. 18, a partial cross section of the channel 21 with the polymer melt arranged in it, and already cooled, and the cooling device 28 additionally arranged within the channel 21 is represented in a simplified form. In this case, the cooling device 28 is formed in a simplified manner in the form of a sinuous line or the form of a wave. In the case of this exemplary embodiment represented here, at the end lying closer to the exit area 22, the cooling device 28 is for example at a temperature of between 60 and 80° C. Partial regions of the cooling elements 37, 38 represented here and delimiting the channel 21 are in this case at a similar temperature of between 60 and 80° C. With appropriate cooling by the cooling elements 37, 38 (both only partially represented), outer regions 56 of the cooled polymer melt that are facing the channel walls 23, 24 are at a temperature of between 100 and 130° C.

A portion 57 directly following the cooling elements 28 is here at a temperature of between 100 and 130° C. A further portion 58, which runs adjacent the portion 57 and extends into the center of the wave form, is at a temperature of about 150° C. At the center of the wave form, a narrow strip of melt is intended to be retained, represented as portion 59 in FIG. 18, this strip being intended to lie in a temperature range between 160 and 170°.

The already previously described large surface area of the cooling device 28 and the way in which the melt strand is divided up in a wave form in its cross section have the effect of significantly facilitating the way in which said strand is deformed after it leaves the portion of the channel 21 with the additional cooling device 28 into the portion of the channel 21 in the exit area 22, since both the decrease in the channel cross section and the decrease in the outer dimension cause a strong compression to be exerted on the polymer melt passing through, and the way in which the polymer melt is divided up in a wave form in its interior makes it easier for it to be shifted or deformed within itself. In this deforming or transitional region between the portion of the channel 21 with the additional cooling device 28 and the portion of the channel 21 in the exit area 22, a temperature equalization takes place within the melt strand between the previously described portions 57 and 59.

In FIG. 19, a partial cross section of the profile shell 18 at the end of the shaping device 3 in its exit area 22 is represented. The division of the temperature ranges within the cross section has been indicated in a simplified manner by dashed lines, various portions 60 to 64 from the outer regions of the profile shell 18 being depicted, and portions with the same reference numerals having the same temperature ranges or temperature values. Thus, the temperature values of the two portions 60 that are directly adjacent the outer regions of the profile shell 18 are about 50° C. The further portions 68, following in the direction of the center of the profile shell 18, are at a temperature of between 60° and 70°, the further portions 62 are at a temperature between 80 and 85° C., the further portions 63 between 85° C. and 90° C. and, finally, the portion 64 arranged at the center is at a temperature of about 100° C. to 110° C.

It is evident from this that at least the outer regions of the profile shell 18 are at such a low temperature that the article 6 emerging from the shaping device 3 is dimensionally stable and the residual heat still contained in the profile can be removed by simple post-cooling.

For the determination of the temperature diagrams in FIGS. 18 and 19, a takeoff rate of 4 m/min was assumed as the takeoff rate for the article 6 from the shaping device 3. The polymer melt entering the shaping device 3 is in this case at a temperature of about 200° C. The representation of the temperature distribution in FIG. 18 has been determined after a time period of 6 sec, this cross section being located, as already previously described, at the end of the additional cooling device 28. In the case of the previously known extrusion installations, having an extrusion die, the polymer melt is still inside the conventionally used extrusion die, where it is still at about 200° C.

Furthermore, in the case of this shaping device 3 it is provided that the extruder 2 forces or pushes the prepared polymer material through the shaping device 3, and it may therefore also be possible to dispense with a caterpillar takeoff 5. In order to avoid compressions of the article 6 emerging from the shaping device 3 as it passes through the cooling device 4, a transporting support with a tensile force of about 2000 N may be used. In this case, this transporting support may take place for example by means of a conveyor belt with suction cups or else a vacuum belt.

In FIG. 20, a portion of the profile shell 18 is shown, illustrating the cooling profile of previously known extruder installations with an extrusion die and subsequent dry calibration. A point in time at which the article 6 to be produced has already entered the dry calibration by about 50 cm has been chosen for this representation. The portions 65 to 69 depicted here, likewise in a simplified form, have a constantly increasing temperature from the first portion 65 represented here in the direction of the interior of the article 6, the portion 65 being at a temperature of about 90° C., the further portion 66 at a temperature of about 110° C., the further portion 67 at about 155° C., the further portion 68 at about 170° C. and, finally, the last portion 69 at a temperature of about 190° C. It can be seen by viewing FIGS. 19 and 20 together that the rapid interior cooling of the melt stream directly after it enters the shaping device 3 causes the polymer melt to be cooled much more quickly than in the case of previously known methods.

The shaping device 3 previously described in detail can be constructed in what is known as a sleeve design, it being possible for the basic body 53 that exteriorly surrounds the shaping device 3 or forms it to be formed from a low-cost standard steel, and possibly configured in a divided form and assembled to form a structural unit. In this case, the overall length of the shaping device 3 according to the invention may for example be between 300 mm and 1000 mm, this being dependent on the output rate. The cooling elements 37 to 42, arranged inside the shaping device 3 for the forming of the melt strand, or the mandrel 26, are formed like sleeves, in such a way that they can be fitted one into the other, and are held in the basic body 53. The latter also provides the supply and discharge of correspondingly required coolant, lubricant, energy etc. Boron nitrite or silicon nitrite or zirconium nitrite may be used for example as ceramic materials. These are distinguished by high wear resistance, high thermal conductivity and tough material.

With advantage, sliding on the walls of the polymer melt to be passed through the channel 21, 46 or the channels 21, 46 is achieved by using a coating. In this case, the correspondingly desired surface properties of the channel walls 23, 24 can be set to the widest variety of requirements and operating conditions over the longitudinal course of the channel 21, 46. Application may take place for example by immersion and subsequent drying, it being possible for the application of such coatings to be performed cyclically, after each cleaning or servicing operation on the shaping device. This coating may be applied both to conventional components made of steel or iron material and to the cooling elements 37 to 42 formed from the widest variety of materials. In this case, the coating may be chosen from the group comprising boron nitrite, silicon nitrite, zirconium nitrite or a nano coating. Sliding of the melt strand on the channel walls 23, 24 can likewise be achieved by surface structures appropriately incorporated in them.

Furthermore, the cooling elements 37 to 42 may be prefabricated as standard components. In this case, an injection-molding process may be used, it being possible here in a simple way to allow for the surface tension with regard to sliding on the walls by appropriate choice of the material and it also being possible for a surface structure to be included in the injection-molding process to improve sliding on the walls. In this way, a modular construction of the shaping device 3 can be achieved.

As a result, components which are formed as one-piece components in a single operation can be created, and they can be assembled in a modular manner to form the shaping device 3 without any great effort being needed to join them together.

In FIGS. 23 and 24, simplified possible ways of carrying out the spatially separate production of the profile shell 18 and webs inside the article 6 are shown.

In the case of the way that is shown in FIG. 23, a single extruder 2 is used, with which a partial stream of the melt stream emerging from it is branched off at the end of the extruder by means of a line 70 (represented in a simplified form) and this partial stream of the polymer melt serves for producing the webs inside the profile shell 18. Represented in a simplified form on the extruder 2 is a two-staged shaping device 71, the inner webs being produced and cooled in the first stage, as already previously described, the supply of the polymer melt taking place via the line 70. The inner webs produced in the first stage are inserted in the second stage, following directly thereafter in the direction of extrusion 7 and are surrounded there by the profile shell 18, or brought together with it, to form the article 6 to be produced as a finished article. The advantages lie in significantly improved cooling, more exact guidance and positioning of the inner webs, minimization of distortion and a more simple construction from the outset.

Likewise represented in FIG. 24 is a two-staged shaping device 71, to which however two extruders are connected. Thus, the extruder 2 aligned in the direction of extrusion 7 delivers the material necessary for producing the webs or inner webs, this material being formed and cooled in the first stage. Here it is possible for example to use small extruders, on account of the small amount necessary for producing the webs. The webs or inner webs produced in the first stage are inserted in the second stage and the finished profile, or the article 6, is completed there by enclosing the webs in the profile shell 18. A greater amount of material is required here, with a larger extruder having to be chosen.

Significantly better cooling, more exact guidance and positioning of the inner webs, minimization of distortion and a more simple construction from the outset are made possible by the shaping device 71 of a two-staged construction. In addition, however, a recycled material, or a material that is different from the profile shell, may be used for the webs arranged inside the profile shell 18, or inner webs.

The shaping devices 71 formed here in a two-staged manner may be constructed according to the previously described design for the shaping device 3 described in detail, it being possible for the webs or inner webs and the profile shell 18 to be brought together in the way represented in FIG. 22. Furthermore, the choice of different shading in FIG. 22 also illustrates that the webs and the profile shell 18 may be produced from different materials or that recycled material may be used for the inner webs.

Represented in FIG. 25 is a strip 72 in band form, which may be used as a starting aid for the forming of the article 6. This strip 72 has transversely in relation to its longitudinal extent between its flat sides a thickness 73 which may correspond approximately to the thickness to be produced of the web inside the profile shell 18. A height 74, determined in a direction perpendicular thereto, of the strip 72 in band form is in this case chosen to be smaller than a length of a web (not represented any more specifically here). On one longitudinal side 75, the strip 72 has a widening 76, which is formed with preference continuously over the length of the entire strip 72. With preference, however, widenings 76 protruding on both sides of the strip in the direction of its thickness 73 are provided, and are formed with preference continuously in the form of a longitudinal rib. In this case, the widenings 76 may be formed in a dovetail-shaped manner in their cross section perpendicularly in relation to the longitudinal extent of the strip 72.

On a further longitudinal side 77, recesses 78 are arranged one after the other in the longitudinal extent of the strip 72, extending from said longitudinal side. These recesses 78 extend from the longitudinal side 77 only over a partial region of the height 74 in the direction of the opposite longitudinal side 75. The form of the recesses 78 is chosen here only by way of example, it also being possible however, independently of this example, to arrange only apertures in the strip 72 instead of the recesses 78 and/or in addition to them.

The strip 72 serves as an automatic starting aid in conjunction with the shaping device 3 or 71 and is pushed into the shaping device 3, 71 in the region of the webs to be produced, from the exit area 22 in the direction of the entry area 19. Since the height 74 is smaller than the width to be produced of the web, during the starting operation the polymer material that is necessary for forming the web is introduced into the channel 46 and made to engage positively there in the recesses 78 on the strips 72 already pushed in. As extrusion progresses, the polymer material introduced into the channel or channels 46 for forming the webs is forced further in the direction of the exit area 22 and the pushed-in strip 72 is thereby forced in the direction of the exit area 22, or it can be withdrawn from the shaping device 3, 71 by pulling it slightly.

This strip 72 in band form makes partially automatic starting possible, the formation in stages previously described in relation to FIGS. 23 and 24 at the same time also being possible in two-staged shaping devices 71.

The strips 72 already inserted into the shaping device 3, 71 before the starting operation may be formed for example from PVC, which may be connected to previously known takeoff devices, whereby starting is made significantly easier. During starting, these strips 72 may also be fused in certain regions with the article 6 to be produced, in particular its webs or profile shell 18, whereby a good resistance to pulling out or a good retaining force within the article 6 can be achieved.

In FIG. 26, a diagram of the temperature profile over a distance is represented in two different lines of the diagram. Thus, the temperature “t” in [° C.] has been plotted on the y axis and the displacement “s” in [mm] has been plotted on the x axis. A solid diagram line 79 shows the temperature profile of the PVC compound in the previously known form, during its cooling, starting from the extruder to when the article 6 leaves the conventionally used cooling tanks. A further, dashed diagram line 80 shows the temperature profile of the PVC compound using the shaping device 3 or 71 according to the invention. A line depicted in the diagram as aligned parallel to the y axis shows the PVC compound at the extruder output 81. A further line, parallel to the latter line, in the region of the first diagram line 79 represents a die end 82. In the extruder, the PVC compound is brought to a temperature of about 200° C. and is output from it at this temperature. While it covers the distance between the extruder output 81 and the die end 82, the PVC compound undergoes a temperature increase within the die as a result of the additional heating and forming, as can be seen from the diagram line 79. A further line, aligned parallel to the y axis, shows a dry calibrating end 83, in which the shaping of the profile shell 18 is performed in a known way. A certain decrease in temperature can already be seen here. Finally, a cooling tank end 84 is represented in a further line, it being possible here for the article 6 to already be at room temperature.

The further diagram line 80, represented by dashed lines, begins at the extruder output 81, the polymer melt that enters the shaping device 3, 71 being cooled by the previously described additional cooling device 28 and cooling elements 37, 38 over a first distance up to a pre-cooling end 85. Already evident from this in comparison with the diagram line 79 is a marked temperature difference, as also represented and described in relation to FIG. 18. After the pre-cooling end, the shaping takes place within the shaping device 3, which ends in a shaping end ˜86, which corresponds to the exit area 22 from the shaping device 3, 71. In the region of the shaping, it is attempted to remove the energy introduced in the course of the shaping from the stream of PVC compound, whereby the temperature profile is represented here as remaining more or less constant.

After it emerges from the shaping device 3, 71, the article 6 undergoes the previously described post-cooling, which is ended with a post-cooling end 87.

Since the previously known die that is used for shaping the completely plasticated melt stream is no longer used, and the polymer melt is already cooled in its interior immediately after it enters the shaping device 3, 71, it enters the shaping process at a significantly lower temperature, and can nevertheless still be formed there into the desired profile cross section 17. As a result, the polymer melt is significantly cooler, and also more stable, in its interior at the end of the shaping process.

The previously described oscillation generator allows for example micro-oscillations to be introduced into the polymer melt, whereby the viscosity is significantly improved. These oscillations or vibrations have the effect that the forming and the sliding movement of the melt strand through the shaping device 3 is significantly improved, or easier distribution takes place in the transitional portion following the portion of the channel 21 with the additional cooling device 28. It is also possible by means of this oscillation generator to lower the melt temperature to a distribution according to the representation of FIG. 18.

In FIG. 27, a further possible embodiment, which may in itself be independent, of the shaping device 3 is shown, the same reference numerals or component designations as in the previous FIGS. 1 to 26 being used in turn for the same components. To avoid unnecessary repetition, reference is likewise made to the detailed description in relation to the previous FIGS. 1 to 26.

In a way similar to the representations of the shaping device 3 according to FIGS. 2 to 21, this shaping device 3 that is represented here in FIG. 27 has the entry area 19 with the inlet opening 20 and the channel 21 extending in the direction of the exit area 22. At the center 25, one or more mandrels 26 may in turn be provided. For the sake of simplicity, a detailed representation of the cooling devices 27, 28 and their supply and discharge lines has not been given here, it being possible for them to be formed for example as described in detail in relation to FIGS. 2 to 21.

In the region of the exit area 22, a portion of the channel 21, which is aligned parallel to the direction of extrusion 7, opens out here. This portion may for example take up about one third to one half of the longitudinal extent of the entire shaping device 3. In this case, a cross section 88 of this portion of the channel 21, which opens out in or is facing the exit area, corresponds to that cross section or that profile contour of the article 6 to be produced. Arranged directly upstream of this portion in the direction of extrusion 7 is a further portion, which has in relation to the portion opening out in or facing the exit area 22 a cross section 89 that is smaller in comparison. In this case, the transition from the portion with the smaller cross section 89 to the portion with the larger cross section 88—that is to say the portion opening out in or facing the exit area—is formed by a transitional area 90 aligned perpendicularly in relation to the direction of extrusion 7. However, it would also be possible independently of this to form this transitional area 90 such that it enlarges at an angle to the direction of extrusion 7, for example conically, as seen in the direction of extrusion 7.

The cross section 89 of the channel 21 in the region of the portion with the smaller cross section 89 is between 5% and 50%, with preference between 10% and 30%, in particular between 15% and 20%, smaller than the cross section 88 of the portion that opens out in or is facing the exit area 22. In this case, values with a lower limit of 5% and an upper limit of 50% are chosen. This constriction of the channel 21 upstream of the entry into the portion that opens out into the exit area 22 serves the purpose of permitting or effecting sliding on the walls in this region, and so produces conditions conducive to a solid flow of the melt stream passing through, or already greatly cooled polymer material, along the channel walls 23, 24.

Furthermore, a longitudinal extent of the channel 21 in the region of that portion with the small cross section 89 is intended to be between 3 times and 20 times, in particular between 5 times and 10 times, the cross section 88 of the portion that opens out in or is assigned to the exit area 22. Consequently, a lower limit amounts to 3 times and an upper limit amounts to 20 times the cross section 88 of the portion that opens out in or is assigned to the exit area 22. This makes it possible for the polymer material passing through to stay in this portion for an adequately long time, in order subsequently to expand appropriately, and go over into a solid flow, when it exits into the portion with the larger cross section 88. The reduction in the cross section 89 of the channel 21 in the region of the portion with the smaller cross section 89 takes place with respect to the portion of the channel 21 that is arranged downstream of it in the direction of extrusion 7 symmetrically in relation to said portion or the cross section 88 thereof. Here, the cross section is understood as meaning the distance between the spaced-apart channel walls 23, 24 in the individual portions.

It is also shown here in a simplified manner that the manifold 55 for supplying the previously already described lubricant is provided and, as seen in the direction of extrusion 7, opens out between the portion of the channel 21 with the smaller cross section 89 and the portion that opens out in or is assigned to the exit area 22. In this case, the lubricant may be introduced into the channel 21 under pressure, the melt stream that passes through in a partial region of the channel 21 being represented in a simplified form. The pressure applied to the lubricant is chosen to be the same as or greater than that pressure that is produced by the melt strand passed through the channel 21. The lubricant introduced under positive pressure has the effect that the melt strand expands only in a gradual transition in the transitional region between the two portions, a receiving or storing space for the lubricant being formed on both sides of the channel walls 23, 24 within the channel 21, between the melt stream and the channel walls 23, 24. The transitional areas 90 aligned perpendicularly in relation to the direction of extrusion 7 are additionally conducive to this.

In FIG. 28, a further possible embodiment, which may in itself be independent, of the shaping device 3 is shown, the same reference numerals or component designations as in the previous FIGS. 1 to 27 being used in turn for the same components. To avoid unnecessary repetition, reference is likewise made to the detailed description in relation to the previous FIGS. 1 to 27.

This shaping device 3 differs from the previously described shaping devices 3 in that an additional cooling device 28 is not necessarily provided in the region of the channel 21. The channel 21 extends in turn between the entry area 19 with its inlet opening 20 and the exit area 22.

The article 6 to be produced (not represented any more specifically here) emerges from the shaping device 3 in the exit area 22 and has here the final cross section 88, which can be predetermined by the channel walls 23, 24. This portion of the channel 21, which opens out in or is assigned to the exit area 22, is aligned such that it runs parallel to the direction of extrusion 7 or the center 25. Assigned to the portion of the channel 21 that opens out in the exit area 22 is a directly upstream portion, which has a cross section 89 that is smaller in comparison.

The further portion of the channel 21 arranged in turn upstream thereof, or the region or portion that is directly downstream of the entry area 19, may correspond substantially to that cross section, or that profile contour, of the article 6 to be produced, or be made smaller than it. The melt strand is fed to the shaping device 3 in the region of the inlet opening 20 and widened here by a mandrel 26 in a way corresponding to the profile contour to be produced. For the sake of better overall clarity, possible webs inside the article 6 to be produced have not been represented.

The individual channel walls 23, 24 delimiting the channel 21 are in turn assigned the cooling devices 27.

However, it would also be possible in the case of this exemplary embodiment shown here to arrange within the channel 21 the additional cooling device 28 for the polymer melt feeding through it in the region or portion that is directly adjacent or downstream of the entry area 19.

As this representation further reveals, the channel 21, and consequently the melt strand of the polymer melt passing through it, is formed directly after the entry area 19, or where it enters the shaping device 3, into a profile contour or a cross section that corresponds substantially to the cross-sectional form of the article 6 that is to be produced. In this case, the melt strand is usually made to pass in parallel through the channels 21, since they are likewise aligned such that they run parallel to the direction of extrusion 7 or the center 25.

Here, in turn, the assignment of the manifold 55 for introducing the lubricant is likewise also possible, as described and shown already in relation to FIG. 27. Likewise, however, the transitional area 90, aligned perpendicularly in relation to the direction of extrusion 7, may also in turn be provided in the region of the transition from the portion with the smaller cross section 89 to the portion that opens out in or is facing the exit area 22. The dimensions of the cross section 89 of the channel 21 in the region of the portion with the smaller cross section 89 may in turn be chosen between 5% and 50%, with preference between 10% and 30%, in particular between 15% and 20%, smaller than the cross section 88 of the portion that opens out in the exit area 22. In this case, values with a lower limit of 5% and an upper limit of 50% are chosen. Consequently, a lower limit is 3 times and an upper limit is 20 times the cross section 88 of the portion that opens out in the exit area 22 or is assigned to it. The longitudinal extent of the channel 21 in the region of the portion with the smaller cross section 89 may also be between 3 times and 20 times, in particular between 5 times and 10 times, the cross section 88 of the portion that opens out in the exit area 22. The reduction in the cross section in the region of the portion with the smaller cross section 89 may also take place with respect to the portion that is arranged downstream of it in the direction of extrusion, with the cross section 88, symmetrically in relation to the channel 21, or its channel walls 23, 24.

The exemplary embodiments show possible configurational variants of the shaping device and its various possibilities for use, it being noted at this point that the invention is not restricted to the configurational variants of the same that are specifically represented, but rather various combinations of the individual configurational variants with one another are possible and this possibility for variation on the basis of the teaching for technical action that is provided by the present invention is within the ability of a person skilled in the art engaged in this technical area. All conceivable configurational variants that are possible by combinations of individual details of the configurational variant represented and described are therefore also covered by the scope of protection.

For the sake of order, it should finally be pointed out that, for better understanding of the construction of the shaping device, it and its component parts have in some cases been represented not to scale and/or enlarged and/or reduced.

The object on which the independent inventive solutions are based can be taken from the description.

In particular, the individual configurations shown in FIGS. 1; 2; 3 to 9; 10, 11; 12 to 15; 16, 17; 18; 19; 20; 21; 22; 23; 24; 25; 26; 27; 28 may form the subject matter of independent solutions according to the invention. The relevant objects and ways of achieving them constituted by solutions according to the invention can be taken from the detailed descriptions of these figures.

### LIST OF REFERENCE NUMERALS

1 extrusion installation
2 extruder
3 shaping device
4 cooling device
5 caterpillar takeoff
6 article
7 direction of extrusion
8 negative pressure tank
9 calibrating plate
10 receiving container
11 machine bed
12 standing area
13 calibrating table
14 running roller
15 running rail
16 calibrating opening
17 profile cross section
18 profile shell
19 entry area
20 inlet opening
21 channel
22 exit area
23 channel wall
24 channel wall
25 center
26 mandrel
27 cooling device
28 cooling device
29 outer dimension
30 inner dimension
31 part
32 part
33 supply line
34 discharge line
35 outer dimension
36 manifold
37 cooling element
38 cooling element
39 cooling element
40 cooling element
41 cooling element
42 cooling element
43 wall part
44 hollow space
45 hollow space
46 channel
47 inflow opening
48 end
49 inner wall
50 transitional region
51 cooling element
52 cooling channel
53 basic body
54 end region
55 manifold
56 outer region
57 portion
58 portion
59 portion
60 portion
61 portion
62 portion
63 portion
64 portion
65 portion
66 portion
67 portion
68 portion
69 portion
70 line
71 shaping device
72 strip
73 thickness
74 height
75 longitudinal side
76 widening
77 longitudinal side
78 recess
79 diagram line
80 diagram line
81 extruder output
82 die end
83 dry calibrating end
84 cooling tank end
85 pre-cooling end
86 shaping end
87 post-cooling end
88 cross section
89 cross section
90 transitional area

1. A shaping device (3) for shaping and cooling articles (6), especially hollow profiles, from a polymer melt, it being possible for said device to be arranged directly downstream of an extruder, with an inlet opening (20), arranged in an entry area (19), for the polymer melt exiting from the extruder (2) and at least one channel (21), which extends in the direction of an exit area (22) and has channel walls (23, 24) delimiting it, and with at least one cooling device (27) assigned to the channel walls (23, 24), characterized in that an additional cooling device (28) for the polymer melt that is to be passed through is arranged within the channel (21) in the region that is directly adjacent or downstream of the entry area (19).

2. A shaping device (3) for shaping and cooling articles (6), especially hollow profiles, from a polymer melt, it being possible for said device to be arranged directly downstream of an extruder, with an inlet opening (20), arranged in an entry area (19), for the polymer melt exiting from the extruder (2) and at least one channel (21), which extends in the direction of an exit area (22) and has channel walls (23, 24) delimiting it, and with at least one cooling device (27) assigned to the channel walls (23, 24), characterized in that the channel (21) has in a portion opening out in or facing the exit area (22) a cross section (88) which corresponds to the article (6) to be produced and the channel (21) has in a portion arranged directly upstream of this portion in the direction of extrusion (7) a cross section (89) that is smaller in comparison.

3. The shaping device (3) as claimed in claim 2, characterized in that an additional cooling device (28) for the polymer melt that is to be passed through is arranged within the channel (21) in the region that is directly adjacent or downstream of the entry area (19).

4. The shaping device (3) as claimed in claim 2 or 3, characterized in that the cross section of the channel (21) in the region or portion that is directly downstream of the entry area (19) corresponds substantially to that cross section of the article (6) to be produced, or is made smaller than it.

5. The shaping device (3) as claimed in one of claims 1, 3 or 4, characterized in that the additional cooling device (28) is assigned to the channel or channels (21) for forming a profile shell (18) of the article (6), especially a hollow profile.

6. The shaping device (3) as claimed in one of claims 1, 3 to 5, characterized in that the additional cooling device (28) has a wavy or sinuous shape, when seen in the direction of extrusion (7).

7. The shaping device (3) as claimed in one of claims 1, 3 to 6, characterized in that the additional cooling device (28) is arranged within the channel (21) at a distance from the channel walls (23, 24).

8. The shaping device (3) as claimed in one of claims 1, 3 to 7, characterized in that the additional cooling device (28) has over its longitudinal extent a decreasing outer dimension (29) in the direction perpendicular to the direction of extrusion (7).

9. The shaping device (3) as claimed in one of claims 1, 3 to 8, characterized in that the additional cooling device (28) is supplied with a cooling medium via a number of supply and discharge lines (33, 34).

10. The shaping device (3) as claimed in claim 9, characterized in that the supply and discharge lines (33, 34) of the additional cooling device (28) are connected to one another in a closed circulation.

11. The shaping device (3) as claimed in claim 10, characterized in that at least one cooler for the cooling medium is provided in the closed circulation.

12. The shaping device (3) as claimed in one of the preceding claims, characterized in that the channel (21) has over its longitudinal extent a differing longitudinal course, with respect to the center (25), between the entry area (19) and the exit area (22).

13. The shaping device (3) as claimed in one of the preceding claims, characterized in that the channel (21) has over its longitudinal extent a differing cross-sectional dimension, in particular a decreasing cross section, between the entry area (19) and the exit area (22).

14. The shaping device (3) as claimed in one of the preceding claims, characterized in that a portion of a mandrel (26) in the region of the additional cooling device (28) has in relation to an inlet opening (20) arranged in the entry area (19) a larger outer dimension (35).

15. The shaping device (3) as claimed in one of the preceding claims, characterized in that at least one of the channel walls (23, 24) in the region of the additional cooling device (28) is assigned at least one cooling element (37, 38) of the cooling device (27).

16. The shaping device (3) as claimed in one of the preceding claims, characterized in that the channel (21) has in the region of the additional cooling device (28) an annular channel cross section in a plane aligned perpendicularly in relation to the direction of extrusion (7).

17. The shaping device (3) as claimed in one of the preceding claims, characterized in that the outer channel wall (23), delimiting the channel (21) in the region of the additional cooling device (28), is formed such that it tapers over its longitudinal extent, with respect to the center (25).

18. The shaping device (3) as claimed in one of the preceding claims, characterized in that a portion of the channel (21) in the region of the exit area (22) corresponds to the cross section to be formed of the article (6) that is to be produced, especially the hollow profile.

19. The shaping device (3) as claimed in claim 18, characterized in that this portion of the channel (21) has a longitudinal extent aligned parallel to the direction of extrusion (7).

20. The shaping device (3) as claimed in one of the preceding claims, characterized in that arranged between the portion of the channel (21) with the additional cooling device (28) and the portion of the channel (21) in the exit area (22) is a further portion with a decreasing cross section, or decreasing dimension, with respect to the center (25).

21. The shaping device (3) as claimed in claim 20, characterized in that the channel (21) at the end of the further portion corresponds virtually to the profile geometry of the article (6), especially the hollow profile (6), that is to be produced.

22. The shaping device (3) as claimed in one of claims 1, 3 to 21, characterized in that the channel (21) has a portion in addition to the portion that opens out in or faces the exit area (22) and is directly upstream of this portion in the direction of extrusion (7), which additional portion has in relation to the portion opening out in the exit area (22) a cross section (89) that is smaller in comparison.

23. The shaping device (3) as claimed in one of the preceding claims, characterized in that the transition from the portion with the smaller cross section (89) to the portion opening out in or facing the exit area (22) is formed by a transitional area (90) aligned perpendicularly in relation to the direction of extrusion (7).

24. The shaping device (3) as claimed in one of the preceding claims, characterized in that the cross section (89) of the channel (21) in the region of the portion with the smaller cross section (89) is between 5% and 50%, with preference between 10% and 30%, smaller than the cross section (88) of the portion that opens out in the exit area (22).

25. The shaping device (3) as claimed in one of the preceding claims, characterized in that a longitudinal extent of the channel (21) in the region of the portion with the smaller cross section (89) is between 3 times and 20 times, in particular between 5 times and 10 times, the cross section (88) of the portion that opens out in the exit area (22).

26. The shaping device (3) as claimed in one of the preceding claims, characterized in that the reduction in the cross section (89) of the channel (21) in the region of the portion with the smaller cross section (89) takes place with respect to the portion of the channel (21) that is arranged downstream of it in the direction of extrusion (7) symmetrically in relation to said portion.

27. The shaping device (3) as claimed in one of the preceding claims, characterized in that all the portions of the channel (21) for forming the profile shell (18) are assigned, at least in certain regions, cooling elements (37 to 42) of the cooling device (27), and these cooling elements (37 to 42) form the channel walls (23, 24).

28. The shaping device (3) as claimed in one of the preceding claims, characterized in that at least some of the channel walls (23, 24) are assigned at least one oscillation generator.

29. The shaping device (3) as claimed in claim 28, characterized in that the oscillation generator or generators is or are arranged between the portion of the channel (21) with the additional cooling device (28) and the portion of the channel (21) in the exit area (22).

30. The shaping device (3) as claimed in one of the preceding claims, characterized in that a manifold (55) for a lubricant opens out into the channel or channels (21, 46), at least in the region of one of the channel walls (23, 24).

31. The shaping device (3) as claimed in claim 30, characterized in that the manifold (55) is formed continuously over the entire circumference of the profile cross section (17).

32. The shaping device (3) as claimed in claim 30 or 31, characterized in that, at the beginning of the portion of the channel (21, 46) with the additional cooling device (28), the manifold (55) opens out into the channel or channels (21, 46), as seen in the direction of extrusion (7).

33. The shaping device (3) as claimed in one of claims 30 to 32, characterized in that, as seen in the direction of extrusion (7), the manifold (55) opens out between the portion of the channel (21) with the smaller cross section (89) and the portion that opens out in the exit area (22).

34. The shaping device (3) as claimed in one of the preceding claims, characterized in that at least one further channel (46) for the forming of webs inside the article (6), especially the hollow profile, is arranged within the mandrel (26).

35. The shaping device (3) as claimed in claim 34, characterized in that the channel (21) for forming the profile shell (18) and the further channel or channels (46) for forming webs run together at the end of the further portion formed between the portion of the channel (21) with the additional cooling device (28) and the portion of the channel (21) in the exit area (22), in mutually facing outer regions.

36. The shaping device (3) as claimed in either of claims 34 and 35, characterized in that the further channel or channels (46) for forming the webs is or are assigned further cooling elements (51).

37. The shaping device (3) as claimed in one of the preceding claims, characterized in that portions of the channel walls (23, 24) delimiting the channel (21) are formed at least in certain regions from a material of a surface tension that is the same as or less than that of the polymer melt to be passed through the channel (21).

38. The shaping device (3) as claimed in one of the preceding claims, characterized in that a coating is applied, at least in certain regions, to the channel walls (23, 24) of the channels (21, 46), or to the cooling elements (37 to 42) delimiting the channels (21, 46).

39. The shaping device (3) as claimed in claim 38, characterized in that the coating is chosen from the group comprising boron nitrite, silicon nitrite, zirconium nitrite or a nano coating.

40. The shaping device (3) as claimed in one of the preceding claims, characterized in that the channel walls (23, 24) of the channels (21, 46) or the cooling elements (37 to 42) delimiting the channels (21, 46) have at least in certain regions a surface structure which makes it possible for the melt strand to slide on the channel walls (23, 24).

41. The shaping device (3) as claimed in one of the preceding claims, characterized in that at least one of the cooling elements (37, 38) in the portion of the channel (21) with the additional cooling device (28) is formed from a polymer material with adequate heat resistance.

42. The shaping device (3) as claimed in one of the preceding claims, characterized in that the cooling elements (37 to 42) are formed like sleeves.

43. The shaping device (3) as claimed in one of the preceding claims, characterized in that the cooling element (41) in the portion of the channel (21) in the exit area (22) is formed from a ceramic material.

44. The shaping device (3) as claimed in one of the preceding claims, characterized in that at least a portion of the mandrel (26) in the portion of the channel (21) in the exit area (22) is formed from a ceramic material.

45. The shaping device (3) as claimed in claim 43 or 44, characterized in that the ceramic material is chosen from the group comprising boron nitrite, silicon nitrite, zirconium nitrite.

46. The shaping device as claimed in one of claims 43 to 45, characterized in that the components formed from the ceramic material are formed in one piece.

47. A method for shaping and cooling articles (6), especially hollow profiles, from a polymer melt, in which the polymer melt is fed to an entry area (19) of a shaping device (3) and said melt is subsequently formed into at least one melt strand by at least one channel (21), which extends in the direction of an exit area (22) and has channel walls (23, 24) delimiting it, and the melt strand or strands is or are formed into the profile contour of the article (6) as it or they pass(es) through the shaping device (3) toward the exit area (22), and is or are thereby cooled, characterized in that, directly after it enters the shaping device (3), the melt strand of the polymer melt is additionally cooled within the same between the channel walls (23, 24) delimiting said device.

48. A method for shaping and cooling articles (6), especially hollow profiles, from a polymer melt, in which the polymer melt is fed to an entry area (19) of a shaping device (3) and said melt is subsequently formed into at least one melt strand by at least one channel (21), which extends in the direction of an exit area (22) and has channel walls (23, 24) delimiting it, and the melt strand or strands is or are formed into the profile contour of the article (6) as it or they pass(es) through the shaping device (3) toward the exit area (22), and is or are thereby cooled, characterized in that the melt strand of the polymer melt is formed in a portion opening out in or facing the exit area (22) into a cross section which corresponds to the article (6) to be produced and the melt strand is formed in a portion arranged directly upstream of the portion opening out in the exit area (22), as seen in the direction of extrusion (7), into a cross section that is smaller in comparison.

49. The method as claimed in claim 48, characterized in that, directly after it enters the shaping device (3), the melt strand of the polymer melt is additionally cooled within the same between the channel walls (23, 24) delimiting said device.

50. The method as claimed in claim 48 or 49, characterized in that, directly after it enters the shaping device (3), the melt strand of the polymer melt is formed into a cross section that corresponds substantially to the cross-sectional form of the article (6) that is to be produced.

51. The method as claimed in one of claims 47 to 50, characterized in that the additional cooling device (28) is assigned to the melt strand or strands for forming a profile shell (18) of the article (6), especially the hollow profile.

52. The method as claimed in one of claims 47 to 51, characterized in that, during its interior cooling, the melt strand is divided up or interrupted by a wavy or sinuous shape, as seen in the direction of extrusion (7).

53. The method as claimed in one of claims 47 to 52, characterized in that the partial streams of the melt strand that are facing the two channel walls (23, 24) are formed continuously over their cross sections during the inner cooling of said strand.

54. The method as claimed in one of claims 47 to 53, characterized in that, as it passes through between the entry area (79) and the exit area (22), the melt strand is formed into a differing longitudinal course, with respect to the center (25).

55. The method as claimed in one of claims 47 to 54, characterized in that, as it passes through between the entry area (19) and the exit area (22), the melt strand is formed into cross sections with dimensions differing from one another.

56. The method as claimed in claim 55, characterized in that the cross-sectional dimension of the melt strand is formed into a decreasing and/or increasing cross section.

57. The method as claimed in claim 55 or 56, characterized in that, before it enters the portion that opens out in or faces the exit area (22), the cross-sectional dimension of the melt strand of the polymer melt is formed in relation to the portion opening out in the exit area (22) into a cross-sectional dimension that is smaller in comparison.

58. The method as claimed in one of claims 55 to 57, characterized in that, as it passes over between the two portions of the channel (21) arranged one behind the other, the melt strand is increased with respect to the upstream portion of the channel (21) with the smaller cross section (89) symmetrically in relation to the latter.

59. The method as claimed in one of claims 47 to 58, characterized in that, after it enters the shaping device (3), the melt strand is transformed or widened in the region of the additional interior cooling in relation to an inlet opening (20) arranged in the entry area (19) to an inner dimension that is larger in comparison.

60. The method as claimed in one of claims 47 to 59, characterized in that the melt strand is cooled in the region of the additional interior cooling at least one region facing the channel walls (23, 24).

61. The method as claimed in one of claims 47 to 60, characterized in that the melt strand is formed in the region of the additional interior cooling into an annular cross section.

62. The method as claimed in one of claims 47 to 61, characterized in that, at least in the region of the additional interior cooling, the melt strand is passed through the channel (21) as a solid flow.

63. The method as claimed in one of claims 47 to 62, characterized in that, in that portion of the channel (21) that opens out in or is facing the exit area (22), the melt strand is passed through the channel (21) as a solid flow.

64. The method as claimed in one of claims 47 to 63, characterized in that, after the interior cooling, the melt strand for forming the profile shell (18) that has been additionally cooled in its interior is formed into the profile cross section (17) to be produced, by reducing its outer dimensions.

65. The method as claimed in one of claims 47 to 63, characterized in that, after the interior cooling, the melt strand for forming the profile shell (18) that has been additionally cooled in its interior is formed into the profile cross section (17) to be produced, by increasing its outer dimensions.

66. The method a claimed in one of claims 47 to 65, characterized in that the melt strand cooled in certain regions is formed in its portion in the region of the exit area (22) into the profile cross section (17) to be formed of the article (6) that is to be produced, especially the hollow profile.

67. The method as claimed in one of claims 47 to 66, characterized in that, as it passes through the shaping device (3), the melt strand is treated with oscillations or vibrations.

68. The method as claimed in claim 67, characterized in that the treatment with oscillations or vibrations is carried out after the additional interior cooling.

69. The method as claimed in one of claims 47 to 68, characterized in that, as it passes through the shaping device (3), the melt strand to be cooled is coated at least in certain regions with a lubricant.

70. The method as claimed in claim 69, characterized in that the coating with the lubricant is carried out over the entire circumference of the melt strand.

71. The method as claimed in claim 69 or 70, characterized in that the coating with the lubricant is applied at the beginning of the additional interior cooling.

72. The method as claimed in one of claims 70 to 72, characterized in that the coating with the lubricant is applied after the additional interior cooling, in particular when the melt strand enters the portion that opens out in or is assigned to the exit area (22).

73. The method as claimed in one of claims 70 to 73, characterized in that the lubricant for forming the coating is introduced into the channel (21) while being subjected to a pressure, the pressure applied to the lubricant being chosen to be the same as or greater than that pressure that is generated by the melt strand passed through the channel (21).

74. The method as claimed in one of claims 47 to 73, characterized in that at least one partial stream is branched off from the melt strand entering the entry area (19), to form at least one web inside the hollow profile.

75. The method as claimed in one of claims 47 to 74, characterized in that, after the interior cooling and the forming of the melt strand to form the profile shell (18), the cooled and formed melt strand for forming the profile shell (18) and the further formed and possibly cooled melt strand or strands for forming webs inside the hollow profile are brought together into the profile geometry that is to be produced.

76. The method as claimed in one of claims 47 to 75, characterized in that, by appropriate selection of the material of the channel walls (23, 24) with respect to its surface tension being the same as or lower than that of the polymer melt, at least in certain regions partial streams of the polymer melt are made to slide along the channel walls (23, 24) delimiting the channel or channels (21, 46).

77. The method as claimed in one of claims 47 to 76, characterized in that the melt strand exiting from the shaping device (3) is cooled to the extent that it is of a dimensionally stable form, at least in the region of its profile shell (18).
